(19) United States
(12) Patent Application Publication
(10) Pub. No.: US 2025/0200954 A1
(43) Pub. Date: Jun. 19, 2025

(54) DATA PROCESSING METHOD, DEVICE, AND COMPUTER-READABLE STORAGE MEDIUM

(71) Applicant: Tencent Technology (Shenzhen) Company Limited, Shenzhen (CN)

(72) Inventors: Bangjie YIN, Shenzhen (CN); Taiping YAO, Shenzhen (CN); Keyue ZHANG, Shenzhen (CN); Bo LI, Shenzhen (CN); Shouhong DING, Shenzhen (CN)

(73) Assignee: Tencent Technology (Shenzhen) Company Limited, Shenzhen (CN)

(21) Appl. No.: 19/072,375

(22) Filed: Mar. 6, 2025

Related U.S. Application Data
(63) Continuation of application No. PCT/CN2024/079587, filed on Mar. 1, 2024.

(30) Foreign Application Priority Data
Mar. 2, 2023 (CN) 202310237098.1

(51) Int. Cl. G06V 10/776; G06V 10/25; G06V 10/26; G06V 10/764; G06V 10/778; G06V 20/70

(52) U.S. Cl. CPC G06V 10/776; G06V 10/25; G06V 10/267; G06V 10/764; G06V 10/778; G06V 20/70

(57) ABSTRACT

A data processing method includes obtaining N sample image sets and an image recognition model, obtaining a sampled sample image from the N sample image sets, inputting the sampled sample image and the wrong class label into the image recognition model to generate a first probability vector of the sampled sample image for the N class labels, obtaining, from the N probability elements in the first probability vector, a first probability element indicating the wrong class label, and adjusting the sampled sample image based on the first probability element, to obtain an adversarial sample image corresponding to the sampled sample image.

### CROSS-REFERENCE TO RELATED APPLICATIONS

This application is a continuation application of International Application No. PCT/CN2024/079587 filed on Mar. 1, 2024, which claims priority to Chinese Patent Application No. 202310237098.1, filed with the China National Intellectual Property Administration on Mar. 2, 2023, the disclosures of each being incorporated by reference herein in their entireties.

### FIELD

The disclosure relates to the field of Internet technologies, and in particular, to a data processing method, a device, a computer-readable storage medium.

### BACKGROUND

In service scenarios such as an image recognition scenario, an image classification scenario, an image recommendation scenario, and a video attribute recognition scenario, it is crucial to correctly determine a class label for an image or video frame (that is, correctly recognize a class of the image or video frame).

In the related art, training data is augmented directly by superimposing randomly generated noise to training sample images. The randomly generated noise and the training sample image are mutually independent data, so that a noise feature in the training sample image superimposed with the random noise and a feature of the image are mutually independent, and the image recognition model can easily distinguish the noise feature from the feature of the image. Therefore, using training samples augmented using a related technology can only enlarge the amount of training data but cannot improve diversity of the training data. As a result, training the image recognition model again with the training samples augmented using the related technology cannot ensure higher class label recognition accuracy and higher recognition generalization performance of a trained image recognition model.

### SUMMARY

Some embodiments provide a data processing method, including: obtaining N sample image sets and an image recognition model, N being a positive integer greater than 1, each of the N sample image sets corresponding to one of N different class labels, the image recognition model being obtained through pre-training based on the N sample image sets, and the N class labels comprising a wrong class label; obtaining a sampled sample image from the N sample image sets, and inputting the sampled sample image and the wrong class label into the image recognition model, to generate a first probability vector of the sampled sample image for the N class labels, the wrong class label being different from a class label corresponding to a sample image set to which the sampled sample image belongs, the first probability vector comprising N probability elements, each of the N probability elements indicating one of the N class labels, and one probability element being used to represent a probability that the sampled sample image belongs to a class label indicated by the probability element; and obtaining, from the N probability elements in the first probability vector, a first probability element indicating the wrong class label, and adjusting the sampled sample image based on the first probability element, to obtain an adversarial sample image corresponding to the sampled sample image, a class prediction result obtained by performing class prediction on the adversarial sample image using the image recognition model being the wrong class label.

Some embodiments provide a data processing apparatus, including: at least one memory configured to store program code; and at least one processor configured to read the program code and operate as instructed by the program code, the program code comprising: data obtaining code configured to cause at least one of the at least one processor to obtain N sample image sets and an image recognition model, N being a positive integer greater than 1, each of the N sample image sets corresponding to one of N different class labels, the image recognition model being obtained through pre-training based on the N sample image sets, and the N class labels comprising a wrong class label; first input code configured to cause at least one of the at least one processor to obtain a sampled sample image from the N sample image sets, and input the sampled sample image and the wrong class label into the image recognition model, to generate a first probability vector of the sampled sample image for the N class labels, the wrong class label being different from a class label corresponding to a sample image set to which the sampled sample image belongs, the first probability vector comprising A probability elements, each of the N probability elements indicating one of the N class labels, and one probability element being used to represent a probability that the sampled sample image belongs to a class label indicated by the probability element; and first adjustment code configured to cause at least one of the at least one processor to obtain, from the N probability elements in the first probability vector, a first probability element indicating the wrong class label, and adjust the sampled sample image based on the first probability element, to obtain an adversarial sample image corresponding to the sampled sample image, a class prediction result obtained by performing class prediction on the adversarial sample image using the image recognition model being the wrong class label.

Some embodiments provide a non-transitory computer-readable storage medium, storing computer code which, when executed by at least one processor, causes the at least one processor to at least: obtain N sample image sets and an image recognition model, N being a positive integer greater than 1, each of the N sample image sets corresponding to one of N different class labels, the image recognition model being obtained through pre-training based on the N sample image sets, and the N class labels comprising a wrong class label; obtain a sampled sample image from the N sample image sets, and input the sampled sample image and the wrong class label into the image recognition model, to generate a first probability vector of the sampled sample image for the N class labels, the wrong class label being different from a class label corresponding to a sample image set to which the sampled sample image belongs, the first probability vector comprising N probability elements, each of the N probability elements indicating one of the N class labels, and one probability element being used to represent a probability that the sampled sample image belongs to a class label indicated by the probability element; and obtain, from the N probability elements in the first probability vector, a first probability element indicating the wrong class label, and adjust the sampled sample image based on the first probability element, to obtain an adversarial sample image corresponding to the sampled sample image, a class prediction result obtained by performing class prediction on the adversarial sample image using the image recognition model being the wrong class label.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an architecture of a system according to some embodiments.

FIG. 2A is a schematic diagram of a data processing scenario according to some embodiments.

FIG. 2B is a schematic diagram of a data processing scenario according to some embodiments.

FIG. 3 is a schematic flowchart of a data processing method according to some embodiments.

FIG. 4 is a schematic diagram of a classification interface trained with clean sample data according to some embodiments.

FIG. 5 is a schematic diagram of a classification interface trained with first mixed sample data according to some embodiments.

FIG. 6 is a schematic diagram of a classification interface trained with second mixed sample data according to some embodiments.

FIG. 7 is a schematic flowchart of a data processing method according to some embodiments.

FIG. 8 is a schematic flowchart of a data processing method according to some embodiments.

FIG. 9 is a schematic diagram of a structure of a data processing apparatus according to some embodiments.

FIG. 10 is a schematic diagram of a structure of a data processing apparatus according to some embodiments.

FIG. 11 is a schematic diagram of a structure of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In some embodiments, the computer device may obtain the A sample image sets and the image recognition model. Each of the A sample image sets corresponds to one of the A different class labels, and the image recognition model is obtained through pre-training based on the A sample image sets, so that the image recognition model can accurately determine a class label for a sample image in the A sample image sets. Further, the computer device obtains the sampled sample image from the A sample image sets, and inputs the wrong class label and the sampled sample image into the image recognition model. The wrong class label belongs to the A class labels. The wrong class label is different from the class label corresponding to the sample image set to which the sampled sample image belongs. The first probability vector of the sampled sample image for the A class labels may be generated using the image recognition model. The first probability vector includes the A probability elements. Each of the A probability elements indicates one of the A class labels. One probability element is used to represent a probability that the sampled sample image belongs to a class label indicated by the probability element. Since the image recognition model can accurately determine the class label for the sample image in the A sample image sets, a probability element in the first probability vector that indicates the correct class label is maximum, or in other words, the probability element indicating the correct class label is far greater than the first probability element indicating the wrong class label. The correct class label is the class label corresponding to the sample image set to which the sampled sample image belongs. Further, the computer device may adjust the sampled sample image based on the first probability element, to obtain the adversarial sample image corresponding to the sampled sample image. The class prediction result obtained by performing class prediction on the adversarial sample image using the image recognition model is the wrong class label. In other words, the sampled sample image is adjusted, so that the image recognition model can misdetermine a class label for the adversarial sample image. Based on the foregoing, the embodiments of this application propose a method for generating an adversarial sample image. According to the method, the adversarial sample image misrecognized by the image recognition model may be generated. The adversarial sample image can improve sample diversity of a training set for optimization training of the image recognition model. The training set with diversified samples can improve accuracy of optimization training of the image recognition model, thereby improving class label recognition accuracy and recognition generalization performance of a trained image recognition model.

For ease of understanding, some terms are first briefly described as follows.

Artificial intelligence (AI) is a theory, method, technology, and application system that uses a digital computer or a machine controlled by a digital computer to simulate, extend, and expand human intelligence, perceive an environment, acquire knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a voice processing technology, a natural language processing technology, ML/deep learning, self driving, and smart transportation.

The CV technology is a science that studies how to use a machine to “see”, and furthermore, is machine vision that a camera and a computer are used for replacing human eyes to perform recognition, measurement, and the like on a target, and further perform graphic processing, so that the computer processes the target into an image more suitable for human eyes to observe, or an image transmitted to an instrument for detection. As a scientific discipline, CV studies related theories and technologies and attempts to establish an AI system that can obtain information from images or multidimensional data. The computer vision technology generally includes technologies such as image processing, image recognition, image semantic understanding, image retrieval, optical character recognition (OCR), video processing, video semantic understanding, video content/behavioral recognition, three-dimensional object reconstruction, a three-dimensional (3D) technology, virtual reality, augmented reality, simultaneous localization and mapping, self driving, and smart transportation. In the embodiments of this application, the CV technology may be used to recognize a class label (for example, a human, a cat, a dog, a real human, a paper man, or a human mold) in an image.

ML is a multi-field interdiscipline, and relates to a plurality of disciplines such as the probability theory, statistics, the approximation theory, convex analysis, and the algorithm complexity theory. ML specializes in studying how a computer simulates or implements a human learning behavior to obtain new knowledge or skills, and reorganize an existing knowledge structure, to keep improving its performance. ML is the core of AI, is a basic way to make the computer intelligent, and is applied to various fields of AI. ML and deep learning generally include technologies such as an artificial neural network, a belief network, reinforcement learning, transfer learning, inductive learning, and learning from demonstrations. In the embodiments of this application, both an image recognition model and an object detection model are ML-based AI models. The image recognition model can be used to recognize an image. The object detection model can be used to detect a key region of a target object in the image.

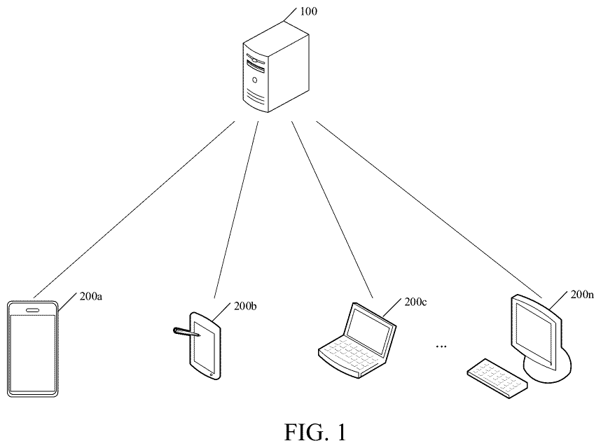

FIG. 1 is a schematic diagram of an architecture of a system according to some embodiments. As shown in FIG. 1, the system may include a service server 100 and a terminal device cluster. The terminal device cluster may include a terminal device 200a, a terminal device 200b, a terminal device 200c, . . . , and a terminal device 200n. The system may include one or more terminal devices. The quantity of terminal devices is not limited herein.

There is a communication connection between the terminal devices. For example, there is a communication connection between the terminal device 200a and the terminal device 200b, and there is a communication connection between the terminal device 200a and the terminal device 200c. In addition, there may be a communication connection between any terminal device in the terminal device cluster and the service server 100. For example, there is a communication connection between the terminal device 200a and the service server 100. A connection manner for the communication connection is not limited. Wired communication may be used for direct or indirect connection, wireless communication may be used for direct or indirect connection, or another manner may be used. This is not limited herein in this application.

An application client may be installed on each terminal device in the terminal device cluster shown in FIG. 1, and when run in each terminal device, the application client may perform data exchange with the service server 100 shown in FIG. 1, that is, the foregoing communication connection. The application client may be an application client with a target image recognition function, for example, a video application, a livestreaming application, a social application, an instant messaging application, a game application, a music application, a shopping application, a novel application, or a browser.

The application client may be an independent client, or an embedded subclient integrated into a specific client (for example, a social client, an educational client, or a multimedia client). This is not limited herein. Taking the shopping application as an example, the service server 100 may be a set including a plurality of servers such as a background server corresponding to the shopping application, and a data processing server. Therefore, each terminal device may perform data transmission with the service server 100 via an application client corresponding to the shopping application. For example, each terminal device may upload a target image to the service server 100 via the application client of the shopping application, so that the service server 100 can determine a class label for the target image.

Related data such as user information (for example, the target image) is involved in a specific implementation of this application. When the embodiments of this application are applied to a specific product or technology, a license or consent of a user is required to be obtained, and collection, use, and processing of the related data are required to comply with related laws and regulations and standards of related countries and regions.

For ease of subsequent understanding and description, in some embodiments, one terminal device may be selected from the terminal device cluster shown in FIG. 1 as a target terminal device. For example, the terminal device 200a is used as the target terminal device. When obtaining an image recognition model and receiving a model optimization instruction for the image recognition model, the terminal device 200a may send a model optimization request for the image recognition model to the service server 100 via the application client. The image recognition model is a neural network model for recognizing an image and determining class information of the image.

Further, after the service server 100 receives the model optimization request sent by the terminal device 200a, the service server 100 may obtain A sample image sets and the image recognition model. “A” as used herein is merely an example term and can be represented using another term. For example, “A sample image sets” may be referred to as “N sample image sets” or the like. The A sample image sets are a plurality of sample image sets. The A sample image sets respectively correspond to different class labels. Therefore, the quantity of class labels may also be A. In other words, each of the A sample image sets corresponds to one of A different class labels. One class label is used to indicate one piece of class information. Therefore, the A sample image sets respectively correspond to different class information. The class information is not limited in herein, and can be set based on an actual application scenario. In some embodiments, the class information may be object information. In this case, the A sample image sets respectively correspond to different object information. For example, object information for a first sample image set among the A sample image sets is a cat (that is, each sample image in the first sample image set is related to the cat), and object information for a second sample image set among the A sample image sets is a dog (that is, each sample image in the second sample image set is related to the dog). In some embodiments, the class information may be object carrier information. In this case, the A sample image sets may respectively correspond to same or different object information, but the A sample image sets respectively correspond to different object carrier information. For example, in a key feature recognition scenario, object carrier information for a third sample image set among the A sample image sets is a screen-captured image, object carrier information for a fourth sample image set among the A sample image sets is a key feature mold, and object carrier information for a fifth sample image set among the A sample image sets is paper.

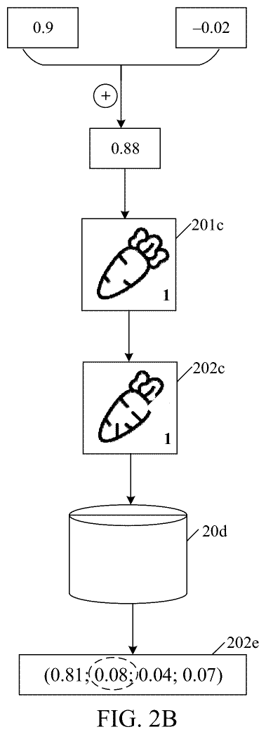

A manner in which the service server 100 obtains the A sample image sets and the image recognition model is not limited herein, and may be set based on the actual application scenario. For example, the model optimization request sent by the terminal device 200a carries the A sample image sets or the image recognition model, or carries both the A sample image sets and the image recognition model. For example, the A sample image sets and the image recognition model are obtained from a database. For example, the A sample image sets and the image recognition model are obtained from a blockchain network. In addition, the image recognition model is obtained through pre-training based on the A sample image sets. For a generation process of the image recognition model, details are not described herein, and reference is made to descriptions of operation S101 in the following embodiment corresponding to FIG. 3.

For ease of description and understanding, a sample image set C1 among the A sample image sets is used as an example for description. A processing process of a remaining sample image set among the A sample image sets is the same as the following processing process of the sample image set C1. The service server 100 obtains a sampled sample image (randomly or through polling) from the sample image set C1, and further obtains a wrong class label from the A class labels. The wrong class label belongs to a class label (which may be referred to as a remaining class label) other than a class label for the sample image set C1 among the A class labels. In some embodiments, a class label randomly obtained from the remaining class label may be determined as the wrong class label. For example, the wrong class label is a class label for a sample image set C2. Further, the wrong class label and the sampled sample image are input into the image recognition model. The wrong class label and the sampled sample image may be respectively input into the image recognition model as two pieces of mutually independent data, and there is a mapping relationship between the wrong class label and the sampled sample image. In some embodiments, the wrong class label is added into a file header or an end of file of the sampled sample image, and the sampled sample image carrying the wrong class label is further input into the image recognition model. Further, the service server 100 generates a first probability vector of the sampled sample image for the A class labels using the image recognition model. The first probability vector includes A probability elements. Each of the A probability elements indicates one of the A class labels. One probability element is used to represent a probability that the sampled sample image belongs to a class label indicated by the probability element. The first probability vector has A vector dimensions. To be specific, an element (also referred to as a probability element in some embodiments) in one vector dimension may represent a predicted probability value for one class label. In other words, a larger value of a probability element indicates a higher probability that the sampled sample image belongs to a class label indicated by the probability element. Therefore, a class label indicated by a probability element with a maximum value in the first probability vector may generally be determined as a class prediction result for the sampled sample image. Therefore, the service server 100 may obtain a first probability element in the first probability vector that indicates the wrong class label, and further adjust the sampled sample image based on the first probability element, to obtain an adversarial sample image corresponding to the sampled sample image. A class prediction result obtained by performing class prediction on the adversarial sample image using the image recognition model is the wrong class label. In other words, the image recognition model cannot accurately recognize the adversarial sample image, and further obtains a wrong class. For example, the sampled sample image is an image including a cat, whose class label is a label corresponding to the cat, and a sampled sample image carrying a label (that is, the wrong class label) corresponding to a dog is adjusted to obtain an adversarial sample image corresponding to the sampled sample image. An optimizer for the image recognition model can accurately determine that the adversarial sample image is an image including the cat, but the image recognition model may misdetermine that the adversarial sample image is an image including the dog.

Through the foregoing process, the service server 100 may generate the adversarial sample image, and subsequently continue to perform optimization training on the image recognition model based on the A sample image sets, a correct class label, and the adversarial sample image, to obtain an optimized image recognition model. The correct class label is the class label for the sample image set C1. A model loss is calculated based on a predicted class label for the adversarial sample image and the correct class label when the image recognition model is trained, so that the trained optimized image recognition model can accurately recognize the adversarial sample image, and further accurately recognize that the class prediction result for the adversarial sample image is the correct class label. Therefore, the optimized image recognition model can have a higher anti-interference capability.

The service server 100 subsequently generates a model optimization complete message for the optimized image recognition model, and sends the model optimization complete message to the terminal device 200a. After receiving the model optimization complete message sent by the service server 100, the terminal device 200a may obtain the optimized image recognition model. A manner in which the terminal device 200a obtains the optimized image recognition model is not limited herein, and may be set based on the actual application scenario. For example, the model optimization complete message carries the optimized image recognition model. For example, the optimized image recognition model is obtained from the database. For example, the optimized image recognition model is obtained from the blockchain network.

In some embodiments, if the terminal device 200a locally stores the image recognition model and the A sample image sets, and the terminal device 200a has an offline calculation capability, when receiving the model optimization instruction for the image recognition model, the terminal device 200a may locally obtain a sample image in the sample image set C1, and use the obtained sample image as the sampled sample image. The terminal device 200a inputs the wrong class label and the sampled sample image into the image recognition model. A subsequent processing process is the same as the foregoing process. Therefore, details are not described herein.

In some embodiments, the wrong class label is assigned to the sampled sample image, the first probability element indicating the wrong class label is obtained using the image recognition model, and the sampled sample image is adjusted based on the first probability element, to obtain the adversarial sample image whose class is mispredicted by the image recognition model. In some embodiments, training sample augmentation and enhancement is performed on the A sample image sets (that is, training data) based on the adversarial sample image, so that richness of a sample training set for optimization training of the image recognition model can be improved, improving recognition accuracy of the optimized image recognition model.

All of the service server 100, the terminal device 200a, the terminal device 200b, the terminal device 200c, . . . , and the terminal device 200n may be blockchain nodes in the blockchain network. Data (for example, the A sample image sets and the image recognition model) described in this description may be stored in a manner that the blockchain node generates a block based on the data and adds the block into a blockchain for storage.

A blockchain is a new application mode of computer technologies such as distributed data storage, point-to-point transmission, a consensus mechanism, and an encryption algorithm, is mainly used to organize data in chronological order, and encrypt the data into a ledger, making the data unforgeable and tamper-proof, and can verify, store, and update data. The blockchain is essentially a decentralized database in which each node stores the same blockchain. In a blockchain network, the node may be distinguished as a core node, a data node, or a light node. Core nodes, data nodes, and light nodes jointly form blockchain nodes. The core node is responsible for consensus in the entire blockchain network. In other words, the core node is a consensus node in the blockchain network. A procedure of writing transaction data into a ledger in the blockchain network may be: The data node or the light node in the blockchain network obtains the transaction data, and transmits the transaction data in the blockchain network (that is, the node transmits the transaction data in a baton manner) until the consensus node receives the transaction data. Then, the consensus node packs the transaction data into a block, performs consensus on the block, and writes the transaction data into the ledger after competing consensus. Herein, the A sample image sets and the image recognition mode are used as example transaction data. After performing consensus on the transaction data, the service server 100 (a blockchain node) generates a block based on the transaction data, and stores the block into the blockchain network. For reading of the transaction data (that is, the A sample image sets and the image recognition model), the blockchain node obtains the block including the transaction data from the blockchain network, and further obtains the transaction data from the block.

A method provided in the embodiments of this application may be performed by a computer device. The computer device may include but is not limited to a terminal device or a service server. The service server may be an independent physical server, a server cluster or distributed system including a plurality of physical servers, or a cloud server providing a basic cloud computing service such as a cloud database, a cloud service, cloud computing, a cloud function, cloud storage, a network service, cloud communication, a middleware service, a domain name service, a security service, a content delivery network (CDN), or a big data and AI platform. The terminal device includes but is not limited to a mobile phone, a computer, an intelligent voice interaction device, a smart home appliance, an in-vehicle terminal, an aircraft, and the like. The terminal device may be connected directly or indirectly to the service server in a wired or wireless manner. This is not limited herein in the embodiments of this application.

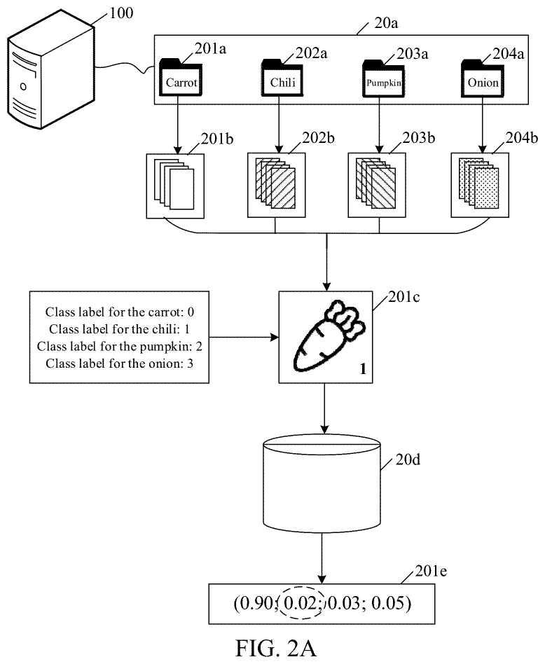

FIG. 2A is a schematic diagram of a data processing scenario according to some embodiments. Some embodiments may be applied to various scenarios, including but not limited to a cloud technology, AI, smart transportation, assisted driving, audios/videos, and the like. Some embodiments may be applied to service scenarios such as an image search scenario, an image generation scenario, an image recommendation service, and an image distribution scenario. The specific service scenarios are not enumerated herein one by one. An implementation process of the data processing scenario may be performed in a service server, may be performed in a terminal device, or may be performed in a terminal device and a service server. This is not limited herein. The terminal device may be any terminal device in the terminal device cluster in the embodiment corresponding to FIG. 1. The service server may be the service server 100 in the embodiment corresponding to FIG. 1. For ease of description and understanding, an example in which the implementation process is performed in the service server is used for description in some embodiments.

As shown in FIG. 2A, the service server 100 may obtain A sample image sets 20a and an image recognition model 20d. A is a positive integer greater than 1. For ease of description and understanding, an example in which A is 4 is used herein. To be specific, there are four sample image sets, such as a sample image set 201a, a sample image set 202a, a sample image set 203a, and a sample image set 204a shown in FIG. 2A (the sample image set 201a, the sample image set 202a, the sample image set 203a, and the sample image set 204a may respectively include the same or different quantities of sample images). The four sample image sets respectively correspond to different class information. For example, as shown in FIG. 2A, class information for the sample image set 201a is a carrot, class information for the sample image set 202a is a chili, class information for the sample image set 203a is a pumpkin, and class information for the sample image set 204a is an onion. Therefore, the service server 100 may respectively set different class labels for the four sample image sets. A class label for the carrot is set to 0, that is, a class label for the sample image set 201a is 0. A class label for the chili is set to 1, that is, a class label for the sample image set 202a is 1. A class label for the pumpkin is set to 2, that is, a class label for the sample image set 203a is 2. A class label for the onion is set to 3, that is, a class label for the sample image set 204a is 3.

For description and understanding, the carrot, the chili, the pumpkin, and the onion are used as example class information in some embodiments. During actual application, the class information is to be set based on an actual scenario. Similarly, for description and understanding, the values 0 to 3 are used as example class labels in some embodiments. During actual application, the class label is to be set based on the actual scenario.

Further, the service server 100 obtains a sampled sample image from each of the four sample image sets, for example, as shown in FIG. 2A, obtains a sampled sample image 201b from the sample image set 201a, obtains a sampled sample image 202b from the sample image set 202a, obtains a sampled sample image 203b from the sample image set 203a, and obtains a sampled sample image 204b from the sample image set 204a. A total quantity of sampled sample images 201b is not limited herein, which may be one or more. Similarly, total quantities respectively corresponding to the sampled sample image 202b, the sampled sample image 203b, and the sampled sample image 204b are not limited herein, all of which may be one or more.

The service server 100 inputs all of the sampled sample image 201b, the sampled sample image 202b, the sampled sample image 203b, and the sampled sample image 204b into the image recognition model 20d. The image recognition model 20d is obtained through pre-training based on the four sample image sets. Processing processes performed by the service server 100 on the sampled sample images using the image recognition model 20d is the same. Therefore, the following uses one sampled sample image (for example, a sampled sample image 201c shown in FIG. 2A) as an example for description. For processing processes of the remaining sampled sample images, refer to the following processing process of the sampled sample image 201c.

The sampled sample image 201c and a wrong class label may be input into the image recognition model 20d. As shown in FIG. 2A, the sampled sample image 201c is an image whose class information is the carrot. In other words, the sampled sample image 201c belongs to the sample image set 201a. A correct class label for the sampled sample image 201c is the class label for the carrot, that is, 0. In FIG. 2A, the class label (that is, 1) for the chili is used as an example of the wrong class label for the sampled sample image 201c (the wrong class label may be obtained through random selection from the chili, the pumpkin, and the onion). The wrong class label for the sampled sample image 201c is randomly generated.

Further, the service server 100 may generate a first probability vector 201e of the sampled sample image 201c for the four class labels using the image recognition model 20d. A dimensionality of the first probability vector 201e is the same as the total quality of class labels, and an element value in each dimension may represent a predicted probability value for a corresponding class label. Therefore, in FIG. 2A, 0.9 in the 1^{st} dimension of the first probability vector 201e may represent a predicted probability for the class label 0, 0.02 in the 2^{nd} dimension may represent a predicted probability for the class label 1, 0.03 in the 3^{rd} dimension may represent a predicted probability for the class label 2, and 0.05 in the 4^{th} dimension may represent a predicted probability for the class label 3. The predicted probabilities in the four dimensions may also be referred to as four probability elements. Based on the first probability vector 201e, the image recognition model 20d can determine that a value of the predicted probability indicating the class label 0 is maximum. Therefore, it may be determined that a class prediction result for the sampled sample image 201c is the class label 0, which is different from the wrong class label (that is, 1) input into the image recognition model 20d. This is because the image recognition model 20d is obtained through pre-training based on the sample image set 201a, the sample image set 202a, the sample image set 203a, and the sample image set 204a in FIG. 2A, and the sampled sample image 201c is from the sample image set 201a. Therefore, the image recognition model 20d recognizes that the class prediction result for the sampled sample image 201c is the class label 0.

Further, the service server 100 may obtain, from the first probability vector 201e using the image recognition model 20d, a first probability element indicating the wrong class label (for example, the class label 1 shown in FIG. 2A), for example, 0.02 shown in FIG. 2A. The service server 100 may adjust the sampled sample image 201c based on the first probability element, to obtain an adversarial sample image corresponding to the sampled sample image 201c.

A specific process of adjusting the sampled sample image 201c based on the first probability element, to obtain the adversarial sample image corresponding to the sampled sample image 201c may include: The service server 100 may adjust the sampled sample image 201c based on the first probability element, to obtain an initial adversarial sample image corresponding to the sampled sample image 201c. FIG. 2B is a schematic diagram of a data processing scenario according to some embodiments. As shown in FIG. 2B, the service server 100 generates a negative probability element corresponding to the first probability element (for example, 0.02 shown in FIG. 2A), that is, −0.02 in FIG. 2B, and performs summation processing on the negative probability element and a maximum probability element (for example, 0.9 shown in FIG. 2A and FIG. 2B) in the first probability vector 201e, to obtain a label loss value of the sampled sample image 201c for the wrong class label, that is, 0.88 in FIG. 2B. Further, the service server 100 adjusts the sampled sample image 201c based on the label loss value, to obtain an initial adversarial sample image 202c corresponding to the sampled sample image 201c. For a specific process of adjusting the sampled sample image 201c based on the label loss value, to obtain the initial adversarial sample image 202c corresponding to the sampled sample image 201c, details are not described herein again, and reference is made to descriptions of operation S103 in the following embodiment corresponding to FIG. 3.

The service server 100 inputs the wrong class label (for example, the class label 1 shown in FIG. 2A and FIG. 2B) and the initial adversarial sample image 202c into the image recognition model 20d. The service server 100 may generate a second probability vector 202e of the initial adversarial sample image 202c for the four class labels using the image recognition model 20d. A meaning of the second probability vector 202e is the same as that of the first probability vector 201e. Therefore, the meaning of the second probability vector 202e is not described herein, and reference is made to the foregoing descriptions of the meaning of the first probability vector 201e.

Further, the service server 100 obtains, from the second probability vector 202e, a second probability element indicating the wrong class label (that is, the class label 1 shown in FIG. 2A and FIG. 2B), for example, 0.08 shown in FIG. 2B. The service server 100 may determine, based on the second probability element, the adversarial sample image corresponding to the sampled sample image 201c. To be specific, the service server 100 may analyze whether the second probability element is a probability element with a maximum value in the second probability vector 202e. If the second probability element is the probability element with the maximum value in the second probability vector 202e, the initial adversarial sample image 202c may be determined as the adversarial sample image corresponding to the sampled sample image 201c (that is, in this case, the image recognition model 20d can misrecognize that a class prediction result for the adversarial sample image is the wrong class label 1); or if it is analyzed that the second probability element is not the probability element with the maximum value in the second probability vector 202e, the initial adversarial sample image 202c is further adjusted, for a larger probability element indicating the wrong class label in a third probability vector output by the image recognition model 20d for an adjusted initial adversarial sample image, until the image recognition model 20d can misrecognize that an adversarial sample image obtained through a plurality of rounds of adjustment is the wrong class label 1.

The class prediction result obtained by the image recognition model 20d for the adversarial sample image is the wrong class label 1. To be specific, the adversarial sample image is still an image including the carrot, but the image recognition model 20d may misrecognize that the class prediction result for the adversarial sample image is the class label 1 for the chili. The service server 100 may subsequently continue to perform optimization training on the image recognition model 20d based on a correct class label (that is, the class label 0 for the carrot) and the adversarial sample image, to obtain an optimized image recognition model. The optimized image recognition model (that is, an image recognition model obtained through optimization training) can accurately recognize that the class prediction result for the adversarial sample image is the class label 0, that is, the class label for the carrot.

Based on the foregoing, the embodiments of this application propose a method for generating an adversarial sample image. According to the method, the adversarial sample image misrecognized by the image recognition model may be generated. The adversarial sample image can improve sample diversity of a training set for optimization training of the image recognition model. The training set with diversified samples can improve accuracy of optimization training of the image recognition model, thereby improving class label recognition accuracy and recognition generalization performance of a trained image recognition model. In addition, the adversarial sample image is an image with strong perturbations (that is, an image that may be misrecognized by the image recognition model) in comparison with the sampled sample image. However, the image recognition model can overcome the strong perturbations, that is, the image recognition model can accurately recognize, using a higher anti-interference capability, that the class prediction result for the adversarial sample image is the correct class label (that is, the class label 0).

FIG. 3 is a schematic flowchart of a data processing method according to some embodiments. The data processing method may be performed by a service server (for example, the service server 100 shown in FIG. 1), may be performed by a terminal device (for example, the terminal device 200a shown in FIG. 1), or may be performed interactively by a service server and a terminal device. For ease of understanding, an example in which the method is performed by the service server is used for description. As shown in FIG. 3, the data processing method may include at least the following operations S101 to S103.

Operation S101: Obtain A sample image sets and an image recognition model, A being a positive integer greater than 1, each of the A sample image sets corresponding to one of A different class labels, the image recognition model being obtained through pre-training based on the A sample image sets, and the A class labels including a wrong class label.

In some embodiments, the service server obtains the A sample image sets. The A sample image sets respectively correspond to different class information. For example, class information for a sample image set is a carrot (that is, each sample image in the sample image set is related to the carrot), and class information for another sample image set is a chili (that is, each sample image in the sample image set is related to the chili). Therefore, the service server may set a different class label for each sample image set. For example, a class label for the carrot is set to 0, that is, a class label for a sample image set whose class information is the carrot is 0. For another example, a class label for the chili is set to 1, that is, a class label for a sample image set whose class information is the chili is 1.

The service server separately inputs the A sample image sets into an initial image recognition model; generates, using the initial image recognition model, predicted initial classes respectively corresponding to the A sample image sets; determines, based on the predicted initial classes respectively corresponding to the sample image sets and class labels respectively corresponding to the sample image sets, class loss values respectively corresponding to the sample image sets; determines, based on the class loss values respectively corresponding to the A sample image sets, a total loss value corresponding to the initial image recognition model; and adjusts a parameter in the initial image recognition model based on the total loss value, to obtain the image recognition model, The image recognition model has a capability of accurately recognizing class prediction results for the A sample image sets. For example, the image recognition model can accurately recognize that a class prediction result for the sample image set whose class information is the carrot is the class label 0 (the class prediction result may also be understood as a class prediction result for each sample image in the sample image set).

A quantity of sample images in the sample image set is not limited herein, which may be one or more. Sample images in the same sample image set corresponds to the same class information, so that sample images in the same sample image set correspond to the same class label. The quantity of sample image sets is also not limited herein, which may be two or more.

In some embodiments, the class label is a label for identifying the class information. The class information is not limited herein, and may be set based on an actual application scenario. For example, the class information may be object information. In this case, each sample image set includes different object information, for example, a cat, a dog, or a vehicle. For example, the class information may be object carrier information. In this case, each sample image set includes different object carrier information, for example, a mask object, a mold object, a photo object, a paper object, or a real object.

A model type of the initial image recognition model is not limited herein. The initial image recognition model may include any one or more neural networks, for example, a convolutional neural network (CNN), a residual network (ResNet), a convolutional neural network based on an extended channel learning mechanism (wide residual network, Wide-ResNet), and a high-resolution net (HRNet).

A specific process in which the service server trains the initial image recognition model may be: separately inputting the A sample image sets into the image recognition model. Processing processes performed by the initial image recognition model on sample images in the A sample image sets are the same. Therefore, the following uses a first sample image carrying a first class label as an example for description. For a processing process of a remaining sample image, refer to the following descriptions. The first sample image is any sample image in the A sample image sets. If the first sample image belongs to a sample image set C1, the first class label is a class label corresponding to the sample image set C1. If the first sample image belongs to a sample image set C2, the first class label is a class label corresponding to the sample image set C2. Other cases are understood as described above, and will not be described in detail one by one. The service server may obtain, using the initial image recognition model, a first initial probability vector corresponding to the first sample image. A dimensionality of the first initial probability vector is the same as A (that is, one dimension corresponds to one class label). An element value (which may also be referred to as a probability element) in each dimension of the first initial probability vector represents a predicted probability for a corresponding class label. A sum of element values in the dimensions is 1. A class label corresponding to a maximum element value in the first initial probability vector is a predicted initial class corresponding to the first sample image. During early training, the predicted initial class corresponding to the first sample image may be different from the first class label. Therefore, the service server may generate, based on the predicted initial class corresponding to the first sample image and the first class label, a class loss value corresponding to the first sample image. Through the foregoing process, the service server may obtain the class loss values respectively corresponding to the sample images in the A sample image sets, and perform summation processing on the obtained class loss values to obtain the total loss value corresponding to the initial image recognition model. Further, the service server adjusts the parameter in the initial image recognition model based on the total loss value, to obtain a pre-trained image recognition model. The image recognition model can accurately recognize a class prediction result for each sample image in the A sample image sets. For example, the image recognition model can accurately recognize that a class prediction result for the first sample image is the first class label. A manner for adjusting the parameter in the initial image recognition model is not limited herein, and may be set based on the actual application scenario. In addition, the quantity of iterations (epochs) of the initial image recognition model is not limited herein, and may be set based on the actual application scenario. A total model loss threshold is also not limited, and may be set based on the actual application scenario.

Operation S102: Obtain a sampled sample image from the A sample image sets, and input the sampled sample image and the wrong class label into the image recognition model, to generate a first probability vector of the sampled sample image for the A class labels, the wrong class label being different from a class label corresponding to a sample image set to which the sampled sample image belongs, the first probability vector including A probability elements, each of the A probability elements indicating one of the A class labels, and one probability element being used to represent a probability that the sampled sample image belongs to a class label indicated by the probability element.

In some embodiments, a sample image set C_{b} among the A sample image sets is used as an example for description, b being a positive integer, and b being less than or equal to A. The service server may determine a sampling ratio, and perform sampling processing on a sample image in the sample image set C_{b} based on the sampling ratio, to obtain the sampled sample image; and obtain, from the A class labels, a class label (which may be randomly obtained) different from a class label for the sample image set C_{b}, and determine the obtained class label as the wrong class label.

Refer back to FIG. 2A. The service server 100 respectively obtains sampled sample images from the four sample image sets. One possible sampling manner is determining a sampling ratio, for example, 5%. In this case, the service server 100 performs random image sampling in the sample image set 201a to obtain 5% of sample images in the sample image set 201a as sampled sample images 201b. For example, if there are 10000 sample images in the sample image set 201a, there are 500 sampled sample images 201b. For generation processes of the sampled sample images corresponding to the other sample image sets (including the sampled sample image 202b, the sampled sample image 203b, and the sampled sample image 204b in FIG. 2A), refer to the generation process of the sampled sample image 201b. Details are not described herein.

For ease of description and understanding, an example in which the sampled sample image 201b in FIG. 2A includes a first sampled sample image and a second sampled sample image is used. Each of the first sampled sample image and the second sampled sample image is a sample image including the carrot, so that correct class labels respectively corresponding to the first sampled sample image and the second sampled sample image are the class label for the carrot, that is, the class label 0 shown in FIG. 2A. An example in which the sampled sample image 202b in FIG. 2A includes a third sampled sample image and a fourth sampled sample image is used. Each of the third sampled sample image and the fourth sampled sample image is a sample image including the chili, so that correct class labels respectively corresponding to the third sampled sample image and the fourth sampled sample image are the class label for the chili, that is, the class label 1 shown in FIG. 2A.

The service server 100 randomly extracts a class label, for example, the class label 1, from the class label 1, the class label 2, and the class label 3 shown in FIG. 2A, and sets the extracted class label as a wrong class label for the first sampled sample image. Similarly, the service server 100 randomly extracts a class label, for example, the class label 2, from the class label 1, the class label 2, and the class label 3 shown in FIG. 2A, and sets the extracted class label as a wrong class label for the second sampled sample image. The service server 100 randomly extracts a class label, for example, the class label 2, from the class label 0, the class label 2, and the class label 3 shown in FIG. 2A, and sets the extracted class label as a wrong class label for the third sampled sample image. Similarly, the service server 100 randomly extracts a class label, for example, the class label 0, from the class label 0, the class label 2, and the class label 3 shown in FIG. 2A, and sets the extracted class label as a wrong class label for the fourth sampled sample image.

Setting processes of wrong class labels for sampled sample images are the same. Therefore, details are not described herein one by one, and reference is made to the setting processes of the wrong class labels for the first sampled sample image, the second sampled sample image, the third sampled sample image, and the fourth sampled sample image.

During actual application, if the image recognition model is used to recognize a real object (for example, a human), in some embodiments, the wrong class label may be set for the sampled sample image through the following process. For ease of description and understanding, an example in which A is 3 is used. To be specific, there are three sample image sets: a sample image set 3a, a sample image set 3b, and a sample image set 3c. Class information for the sample image set 3a is the real object whose class label is 30a. Class information for the sample image set 3b is a paper object whose class label is 30b. Class information for the sample image set 3c is a mask object whose class label is 30c. In this case, the sample image set 3b and the sample image set 3c may be considered as attack sample image sets for the sample image set 3a.

A process in which the service server obtains sampled sample images respectively corresponding to the sample image set 3a, the sample image set 3b, and the sample image set 3c are the same as the foregoing process, and thus is not described herein in detail. It is assumed that the sampled sample image in the sample image set 3a includes a fifth sampled sample image and a sixth sampled sample image, the sampled sample image in the sample image set 3b includes a seventh sampled sample image and an eighth sampled sample image, and the sampled sample image in the sample image set 3c includes a ninth sampled sample image and a tenth sampled sample image. The service server 100 randomly extracts a class label, for example, the class label 30b, from the class label 30b and the class label 30c, and sets the extracted class label as a wrong class label for the fifth sampled sample image. Similarly, the service server 100 randomly extracts a class label, for example, the class label 30c, from the class label 30b and the class label 30c, and sets the extracted class label as a wrong class label for the sixth sampled sample image. The service server sets the class label 30a as wrong class labels respectively corresponding to the seventh sampled sample image, the eighth sampled sample image, the ninth sampled sample image, and the tenth sampled sample image. Therefore, some embodiments provide two wrong class label setting methods. During actual application, one of the two setting methods may be selected as actually needed.

Further, the service server inputs the sampled sample images respectively corresponding to the A sample image sets into the image recognition model. Processing processes performed by the image recognition model on the sampled sample images are the same. Therefore, refer to the related descriptions of the sampled sample image 201c in the foregoing embodiment corresponding to FIG. 2A.

The image recognition model can obtain a first probability vector corresponding to each sampled sample image. Each first probability vector includes A probability values (which may also be referred to as probability elements). Since the image recognition model is obtained through pre-training based on the A sample image sets, the image recognition model can output a correct probability distribution for each sampled sample image (the correct probability distribution indicates that a probability value in the output first probability vector that indicates a correct class label is maximum). For ease of understanding, refer back to FIG. 2A. For each sampled sample image (including the sampled sample image 201c) in the sampled sample images 201b, the 1^{st} element (which may also be referred to as a probability element for indicating the class label 0, the probability element being used to represent a probability that the sampled sample image belongs to the class label 0 indicated by the probability element) in a first probability vector (including the first probability vector 201e shown in FIG. 2A) output by the image recognition model 20d may be infinitely close to 1, while the other three elements may be infinitely close to 0. For each sampled sample image in the sampled sample images 202b, the 2^{nd} element in a first probability vector output by the image recognition model 20d may be infinitely close to 1, and the other three elements (for example the 1^{st} element, the 3^{rd} element, and the 4^{th} element) may be infinitely close to 0. For each sampled sample image in the sampled sample images 203b, the 3^{rd} element in a first probability vector output by the image recognition model 20d may be infinitely close to 1, and the other three elements (for example the 1^{st} element, the 2^{nd} element, and the 4^{th} element) may be infinitely close to 0. For each sampled sample image in the sampled sample images 204b, the 4^{th} element in a first probability vector output by the image recognition model 20d may be infinitely close to 1, and the other three elements (for example the 1^{st} element, the 2^{nd} element, and the 3^{rd} element) may be infinitely close to 0.

Operation S103: Obtain, from the A probability elements in the first probability vector, a first probability element indicating the wrong class label, and adjust the sampled sample image based on the first probability element, to obtain an adversarial sample image corresponding to the sampled sample image, a class prediction result obtained by performing class prediction on the adversarial sample image using the image recognition model being the wrong class label.

In some embodiments, the service server adjusts the sampled sample image based on the first probability element, to obtain an initial adversarial sample image corresponding to the sampled sample image, and inputs the wrong class label and the initial adversarial sample image into the image recognition model. The wrong class label and the initial adversarial sample image may be input into the image recognition model as two pieces of mutually independent data, and there is a mapping relationship between the wrong class label and the initial adversarial sample image. In some embodiments, the wrong class label is added into a file header or an end of file of the initial adversarial sample image, and the initial adversarial sample image carrying the wrong class label is further input into the image recognition model. A second probability vector of the initial adversarial sample image for the A class labels is generated using the image recognition model. The second probability vector also includes A probability elements. Each of the A probability elements indicates one of the A class labels. One probability element is used to represent a probability that the initial adversarial sample image belongs to a class label indicated by the probability element. A second probability element in the second probability vector that indicates the wrong class label is obtained, and the adversarial sample image corresponding to the sampled sample image is determined based on the second probability element. One manner of determining the adversarial sample image is as follows: The service server may analyze whether the second probability element is a probability element with a maximum value in the second probability vector. If the second probability element is the probability element with the maximum value in the second probability vector, the initial adversarial sample image may be determined as the adversarial sample image corresponding to the sampled sample image (that is, in this case, the image recognition model can misrecognize that the class prediction result for the adversarial sample image is the wrong class label); or if it is analyzed that the second probability element is not the probability element with the maximum value in the second probability vector, the initial adversarial sample image is further adjusted, for a larger probability element indicating the wrong class label in a third probability vector output by the image recognition model for an adjusted initial adversarial sample image, until the image recognition model can misrecognize that an adversarial sample image obtained through a plurality of rounds of adjustment is the wrong class label.

A specific process of adjusting the sampled sample image based on the first probability element, to obtain the initial adversarial sample image corresponding to the sampled sample image may include: generating a negative probability element corresponding to the first probability element, and performing summation processing on the negative probability element and a maximum probability element in the first probability vector, to obtain a label loss value of the sampled sample image for the wrong class label; and adjusting the sampled sample image based on the label loss value, to obtain the initial adversarial sample image corresponding to the sampled sample image. If the initial adversarial sample image can be directly used as the adversarial sample image corresponding to the sampled sample image, the sampled sample image may be adjusted based on the label loss value, to directly obtain the adversarial sample image corresponding to the sampled sample image.

A specific process of adjusting the sampled sample image based on the label loss value, to obtain the initial adversarial sample image corresponding to the sampled sample image may include: generating an initial gradient value for the sampled sample image based on the label loss value, obtaining a numerical sign of the initial gradient value, and generating, based on the numerical sign, a signed unit value corresponding to the initial gradient value; performing product processing on an initial learning rate and the signed unit value to obtain a first to-be-clipped value, and performing clipping processing on the first to-be-clipped value using a first clipping interval generated based on an attack intensity, to obtain a gradient value for adjusting the sampled sample image; and performing difference calculation processing on the sampled sample image and the gradient value (the gradient value may also be referred to as a perturbation value, and the difference calculation processing may be understood as adding the perturbation value into the sampled sample image to obtain a noisy image) to obtain a second to-be-clipped value, and performing clipping processing on the second to-be-clipped value using a second clipping interval generated based on a pixel level, to obtain the initial adversarial sample image corresponding to the sampled sample image (if the initial adversarial sample image can be directly used as the adversarial sample image corresponding to the sampled sample image, the initial adversarial sample image herein may be directly referred to as the adversarial sample image).

In some embodiments, after the service server obtains the first probability vector of the sampled sample image, the service server uses the maximum probability element in the first probability vector as a first loss value, uses, as a second loss value, the first probability element in the first probability vector that corresponds to the wrong class label, and uses a difference between the first loss value and the second loss value as the label loss value of the sampled sample image for the wrong class label. Further, the service server adjusts the sampled sample image based on the label loss value, to obtain the initial adversarial sample image for the sampled sample image. A specific implementation may use a project gradient descent (PGD) attack algorithm (an iterative attack algorithm). A specific implementation process based on the PGD attack algorithm may be described with the following formula (1).

$${I}_{T}^{{adv}^{t}} = clip \{ α * sign ( {∇}_{{I}_{T}^{{adv}^{t - 1}}} {L}_{adv}^{t} ) , [ - eps , eps ] \} , [ 0 , 225 ] \} \qquad ( 1 )$$

In the formula (1), t represents a current iteration, and t is a positive integer. In other words, the image recognition model may perform iteration at least once, that is, the sampled sample image may be adjusted at least once. I_{T}^{adv}^{^{t}} represents result data obtained through a t^{th} iteration, for example, the initial adversarial sample image generated after the 1^{st} iteration, or the adversarial sample image generated after the last iteration. I_{T}^{adv}^{^{t-1}} represents input data for the t^{th} iteration. For example, input data for the 1^{st} iteration is the sampled sample image. If there is the 2^{nd} iteration, input data for the 2^{nd} iteration is the initial adversarial sample image, that is, the result data obtained through the 1^{st} iteration. Similarly, if there are more iterations, input data for a next iteration is result data obtained through a previous iteration.

$${∇}_{{I}_{T}^{{adv}^{t - 1}}} {L}_{adv}^{t} = \frac{\partial {L}_{adv}^{t}}{\partial {I}_{T}^{{adv}^{t - 1}}}$$

represents the initial gradient value. L_{adv}^{t} represents a label loss value obtained after the t^{th} iteration, for example, a label loss value obtained after the 1^{st} iteration. α represents the learning rate. sign(.) represents a sign function. The sign function can change each element of the initial gradient value (map to {−1, 0, 1}. eps represents the attack intensity. To be specific, an absolute value of each element value of a gradient map for adjustment each time is required not to be greater than the attack intensity. The attack intensity is an adjustable parameter, and is generally set to 8/255, 16/255, 32/255, or the like. A clip(.,.) function represents clipping. In other words, the clip(.,.) function can control all values within a specified closed interval range. [−eps, eps] represents the first clipping interval. [0, 255] represents the second clipping interval.

An image adjustment manner is not limited herein, and may be the foregoing PGD attack method or another attack method, for example, a fast gradient sign method (FGSM) (a gradient-based adversarial sample generation algorithm), an iterative fast gradient sign method (I-FGSM) (an improved FGSM), and a momentum iterative fast gradient sign method (MI-FGSM) (another improved FGSM).

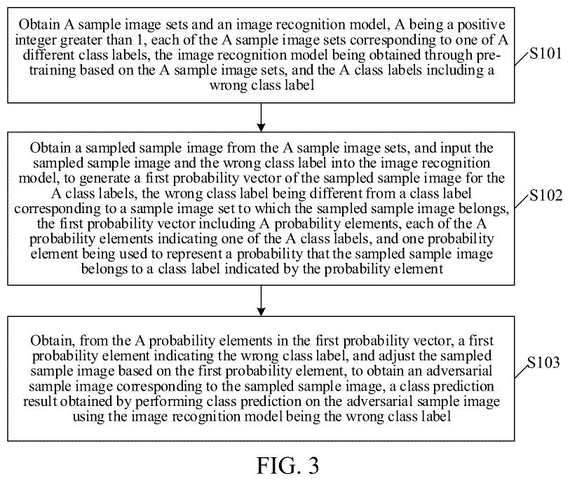

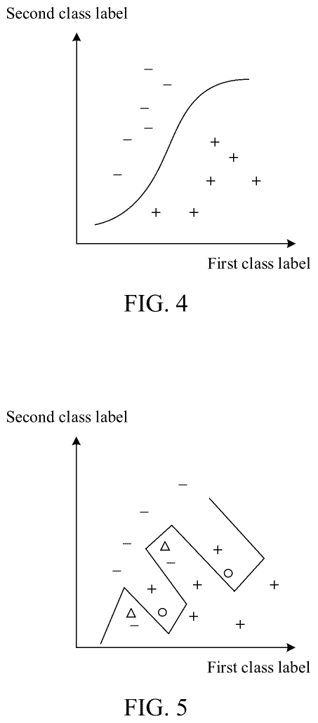

Further, the service server inputs the wrong class label and the initial adversarial sample image into the image recognition model, and generates the second probability vector of the initial adversarial sample image for the A class labels using the image recognition model. Generally speaking, to implement a successful adversarial attack, α and the quantity t of iterations are required to satisfy specific values, to ensure that an adjusted sampled sample image can cross an interface of the image recognition model and become a sample image that can be recognized by the image recognition model as the wrong class label (for distinguishing from the adversarial sample image, the sample image herein is referred to as a strong adversarial sample image, that is, a probability element that is output by the image recognition model for the strong adversarial sample image and that indicates a wrong class label approaches 1). However, selecting such a strong adversarial sample image can improve robustness of the image recognition model, but cannot be used to improve accuracy of the image recognition model as appropriate data enhancement means. This is because the strong adversarial sample image is totally in a distribution for the wrong class label, and if optimization training is performed on the image optimization model using the strong adversarial sample image, an interface of an image recognition model obtained through optimization training may become an ungentle curve, for example, a zigzag curve. Refer to FIG. 4 and FIG. 5. FIG. 4 is a schematic diagram of a classification interface trained with clean sample data according to some embodiments. FIG. 5 is a schematic diagram of a classification interface trained with first mixed sample data according to some embodiments. The clean sample data is the foregoing A sample image sets. The first mixed sample data includes the foregoing A sample image sets and the foregoing strong adversarial sample image. For ease of description and understanding, A may be equal to 2. In other words, the A class labels include the first class label and the second class label shown in FIG. 4 and FIG. 5. In some embodiments, A is greater than 2, where one class label is used as a real class label, and one or more remaining class labels are used as attack class labels. In FIG. 4, a class feature distribution region (that is, a region in which signs “+” are located) corresponding to the first class label and a class feature distribution region (that is, a region in which signs “−” are located) corresponding to the second class label are mutually independent. In other words, the image recognition model can accurately recognize the first class label and the second class label.

In FIG. 5, class feature distribution regions (that is, regions in which signs “+” are located and regions in which signs “Δ” is located) corresponding to the first class label and class feature distribution regions (that is, regions in which signs “−” are located and regions in which signs “○” are located) corresponding to the second class label are mutually independent. To better fit the strong adversarial sample image, the interface of the image recognition model is changed to be zigzag. This can improve robustness of an image recognition model obtained through optimization for strong adversarial sample data, but may misclassify some sample images that are close to the interface and whose confidences are not high. For example, in FIG. 5, some signs “−” are located in the class feature regions corresponding to the first class label, and some signs “+” are located in the class feature regions corresponding to the second class label. In this case, the image recognition model cannot accurately recognize the first class label and the second class label, that is, accuracy of the image recognition model obtained through optimization is damaged. If A is greater than 2, and the real class label and the attack class label are not distinguished, the quantity of class feature distribution regions is the same as A. For example, if A=3, there are three class feature distribution regions.

Based on the foregoing analysis, an objective of some embodiments is to improve accuracy and generalization performance of the image recognition model while improving the robustness. Therefore, A boundary constraint is added in some embodiments, to screen the adversarial sample image. In other words, the adversarial sample image for data enhancement is required not to be excessively far from the boundary. Therefore, another manner for determining the adversarial sample image may be as follows: The service server adjusts the sampled sample image based on the first probability element, to obtain an initial adversarial sample image corresponding to the sampled sample image; inputs the wrong class label and the initial adversarial sample image into the image recognition model, and generates a second probability vector of the initial adversarial sample image for the A class labels using the image recognition model; obtains a second probability element for the wrong class label from A probability elements included in the second probability vector; and continues to adjust the initial adversarial sample image based on the second probability element if the second probability element does not satisfy the boundary constraint or the class prediction result obtained by performing class prediction on the adversarial sample image is not the wrong class label (a process of continuing to adjust the initial adversarial sample image is the same as the specific implementation process of adjusting the sampled sample image based on the first probability element, to obtain the initial adversarial sample image, so that details are not described herein, and reference is made to the foregoing descriptions; and an image adjustment manner in a subsequent model iteration process (that is, an image adjustment process) is the same as the adjustment manner for the sampled sample image); or determines, if the second probability element satisfies the boundary constraint or the class prediction result obtained by performing class prediction on the adversarial sample image is the wrong class label, the initial adversarial sample image as the adversarial sample image corresponding to the sampled sample image, the second probability element being a maximum value among the A probability elements included in the second probability vector in a case that the class prediction result is the wrong class label. The adversarial sample image is expected in some embodiments to not only satisfy the boundary constraint but also ensure that the image recognition model can misrecognize the adversarial sample image. The service server may further compare the second probability element with a probability constraint value, the probability constraint value being a reciprocal of A; and determine, if the second probability element is less than the probability constraint value, that the second probability element does not satisfy the boundary constraint; or determine, if the second probability element is greater than or equal to the probability constraint value, that the second probability element satisfies the boundary constraint. In some embodiments, the learning rate and the quantity of iterations are controlled. If a probability element (including the foregoing second probability element) in a probability vector (including the foregoing second probability vector) that corresponds to the wrong class label is greater than 1/A, and the probability element corresponding to the wrong class label is a maximum value in the probability vector (the probability element with the maximum value is used to indicate that a class prediction result obtained by the image recognition model for the initial adversarial sample image is a class label indicated by the probability element), model iteration (that is, image adjustment) is stopped, and a currently adjusted sample image is used as an appropriate adversarial sample image, without waiting for the probability element corresponding to the wrong class label to approach 1.

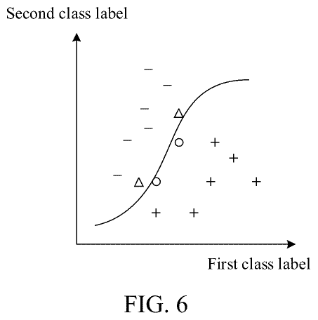

Based on the foregoing, the adversarial sample image obtained in some embodiments may be located close to the classification interface rather than in the distribution for the wrong class label, so that the classification interface of the image recognition model obtained through optimization training with the adversarial sample image may be gentler. FIG. 6 is a schematic diagram of a classification interface trained with second mixed sample data according to some embodiments. The second mixed sample data includes the foregoing A sample image sets and the foregoing adversarial sample image. As shown in FIG. 6, there is substantially no interaction between class feature distribution regions (that is, a region in which signs “+” are located and a region in which signs “Δ” are located) corresponding to the first class label and class feature distribution regions (that is, a region in which signs “−” are located and a region in which signs “○” are located) corresponding to the second class label, and a few interactive class features are substantially located on the classification interface. In this case, the image recognition model obtained through optimization can accurately recognize the first class label and the second class label. In other words, it can be ensured that the optimized image recognition model (referred to as an optimized image recognition model) can compensate for deficiencies of training data on the basis of maintaining or improving the original recognition accuracy. Therefore, a defense capability and safety of the optimized image recognition model can be improved.

Some embodiments provide brand-new boundary constraint-based adversarial data enhancement, to augment and enhance the training data using particularity of adversarial data in boundary distribution, thereby improving the defense capability and the generalization performance of the image recognition model obtained through optimization.

In some embodiments, a computer device may obtain the A sample image sets and the image recognition model. Each of the A sample image sets corresponds to one of the A different class labels, and the image recognition model is obtained through pre-training based on the A sample image sets, so that the image recognition model can accurately determine a class label for a sample image in the A sample image sets. Further, the computer device obtains the sampled sample image from the A sample image sets, and inputs the wrong class label and the sampled sample image into the image recognition model. The wrong class label belongs to the A class labels. The wrong class label is different from the class label corresponding to the sample image set to which the sampled sample image belongs. The first probability vector of the sampled sample image for the A class labels may be generated using the image recognition model. The first probability vector includes the A probability elements. Each of the A probability elements indicates one of the A class labels. One probability element is used to represent a probability that the sampled sample image belongs to a class label indicated by the probability element. Since the image recognition model can accurately determine the class label for the sample image in the A sample image sets, a probability element in the first probability vector that indicates the correct class label is maximum, or in other words, the probability element indicating the correct class label is far greater than the first probability element indicating the wrong class label. The correct class label is the class label corresponding to the sample image set to which the sampled sample image belongs. Further, the computer device may adjust the sampled sample image based on the first probability element, to obtain the adversarial sample image corresponding to the sampled sample image. The class prediction result obtained by performing class prediction on the adversarial sample image using the image recognition model is the wrong class label. In other words, the sampled sample image is adjusted, so that the image recognition model can misdetermine a class label for the adversarial sample image. Based on the foregoing, some embodiments provide a method for generating an adversarial sample image. According to the method, the adversarial sample image misrecognized by the image recognition model may be generated. The adversarial sample image can improve sample diversity of a training set for optimization training of the image recognition model. The training set with diversified samples can improve accuracy of optimization training of the image recognition model, thereby improving class label recognition accuracy and recognition generalization performance of a trained image recognition model. In addition, since the second probability element for the wrong class label that is predicted by the image recognition model for the adversarial sample image satisfies the boundary constraint, the classification interface of the image recognition model obtained through optimization training is more gentile, further ensuring model accuracy.

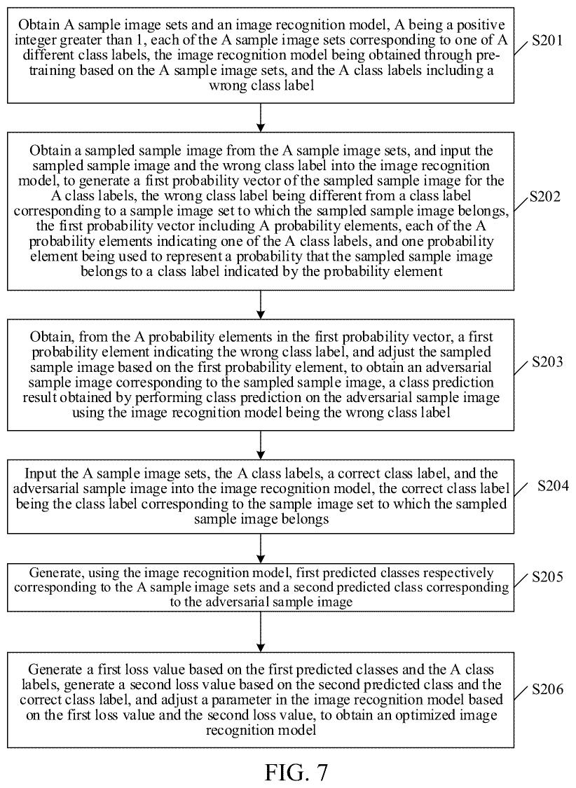

FIG. 7 is a schematic flowchart of a data processing method according to some embodiments. The method may be performed by a service server (for example, the service server 100 shown in FIG. 1), may be performed by a terminal device (for example, the terminal device 200a shown in FIG. 1), or may be performed interactively by a service server and a terminal device. For ease of understanding, an example in which the method is performed by the service server is used for description. As shown in FIG. 7, the method may include at least the following operations.

Operation S201: Obtain A sample image sets and an image recognition model, A being a positive integer greater than 1, each of the A sample image sets corresponding to one of A different class labels, the image recognition model being obtained through pre-training based on the A sample image sets, and the A class labels including a wrong class label.

In some embodiments, the service server obtains A original image sets, and inputs all the A original image sets into an object detection model, each of the A original image sets corresponding to one of A different pieces of class information, the A original image sets including an original image set D_{b}, the original image set D_{b} including an original image E_{f}, f being a positive integer, and f being less than or equal to a total quantity of original images in the original image set D_{b}; determines regional coordinates of a key region in the original image E_{f} using the object detection model, and generates, based on the regional coordinates, a to-be-labeled sample image corresponding to the original image E_{f}; determines a to-be-labeled sample image corresponding to each original image in the original image set D_{b} as a to-be-labeled sample image set; and generates a class label H_{b} based on class information corresponding to the original image set D_{b}, and determines a to-be-labeled sample image set labeled with the class label H_{b} as the sample image set C_{b}.

A specific process of generating, based on the regional coordinates, the to-be-labeled sample image corresponding to the original image E_{f} may include: generating, based on the regional coordinates, an initial detection box including the key region, and performing expansion processing on the initial detection box to obtain a detection box comprising a target object, the key region belonging to the target object; obtaining, from the detection box, a to-be-scaled image comprising the target object, obtaining a first image size, and performing scaling processing on the to-be-scaled image based on the first image size, to obtain a to-be-cropped image; and obtaining a second image size, and performing cropping processing on the to-be-cropped image based on the second image size, to obtain the to-be-labeled sample image corresponding to the original image E_{f}, the second image size being smaller than the first image size.

A model type of the object detection model is not limited by the service server, and may be set based on an actual application scenario, for example, region with CNN feature (Faster R-CNN for short) (a target detection model), single shot multibox detector (SSD for short) (another target detection model), and you only look once (YOLO for short) (a simple and convenient target detection algorithm).

The key region belongs to the target object. The target object is not limited herein, for example, may be a cat, a dog, a human, a desk, or a chili. Therefore, the key region is not limited, and is to be set based on the target object. An expansion factor for the initial detection box is to be set based on the key region. Therefore, the expansion factor is not limited herein. The second image size is an input size for the image recognition model.

Operation S202: Obtain a sampled sample image from the A sample image sets, and input the sampled sample image and the wrong class label into the image recognition model, to generate a first probability vector of the sampled sample image for the A class labels, the wrong class label being different from a class label corresponding to a sample image set to which the sampled sample image belongs, the first probability vector including A probability elements, each of the A probability elements indicating one of the A class labels, and one probability element being used to represent a probability that the sampled sample image belongs to a class label indicated by the probability element.

Operation S203: Obtain, from the A probability elements in the first probability vector, a first probability element indicating the wrong class label, and adjust the sampled sample image based on the first probability element, to obtain an adversarial sample image corresponding to the sampled sample image, a class prediction result obtained by performing class prediction on the adversarial sample image using the image recognition model being the wrong class label.

For specific implementation processes of operation S202 and operation S203, refer to the descriptions of operation S102 and operation S103 in the embodiment corresponding to FIG. 3. Details are not described herein.

Operation S204: Input the A sample image sets, the A class labels, a correct class label, and the adversarial sample image into the image recognition model, the correct class label being the class label corresponding to the sample image set to which the sampled sample image belongs.

The A sample image sets, the A class labels, the correct class label, and the adversarial sample image may be respectively input into the image recognition model as four pieces of mutually independent data, and there is a mapping relationship between the A sample image sets and the A class labels and a mapping relationship between the correct class label and the adversarial sample image. In some embodiments, a class label to which a sample image in a sample image set belongs is added into a file header or an end of file of the sample image, the correct class label is added into a file header or an end of file of the adversarial sample image, and the sample image carrying the class label and the adversarial sample image carrying the correct class label are further input into the image recognition model.

Operation S205: Generate, using the image recognition model, first predicted classes respectively corresponding to the A sample image sets and a second predicted class corresponding to the adversarial sample image.

Operation S206: Generate a first loss value based on the first predicted classes and the A class labels, generate a second loss value based on the second predicted class and the correct class label, and adjust a parameter in the image recognition model based on the first loss value and the second loss value (for example performing weighted summation on the first loss value and the second loss value to obtain a total loss value, and then adjusting the parameter in the image recognition model based on the total loss value), to obtain an optimized image recognition model, a class prediction result obtained by performing class prediction on the adversarial sample image using the optimized image recognition model being the correct class label, and a class prediction result obtained by performing class prediction on the sample image in the sample image set using the optimized image recognition model being still a class label corresponding to the sample image set.

A process in which the service server performs optimization training on the image recognition model is the same as a process in which the service server trains an initial image recognition model. Therefore, for specific implementation processes of operation S204 to operation S206, refer to the descriptions of operation S101 in the embodiment corresponding to FIG. 3. Details are not described herein.

The optimized image recognition model proposed in some embodiments may be deployed on the terminal device. For example, detection is performed on an image input for real object recognition (for example, real human recognition); and if a real object is detected, a subsequent recognition procedure is entered, or if no real object is detected, for example, a photo object is detected, an error is reported, and a prompt is given for retry. Some embodiments may be applied to all applications related to object recognition, including but not limited to: online payment, offline payment, an access control unlocking system, recognition for unlocking a mobile phone, automatic object recognition clearance, and the like.

Based on the foregoing, some embodiments provide a method for generating an adversarial sample image. According to the method, the adversarial sample image misrecognized by the image recognition model may be generated. The adversarial sample image can improve sample diversity of a training set for optimization training of the image recognition model. The training set with diversified samples can improve accuracy of optimization training of the image recognition model, thereby improving class label recognition accuracy and recognition generalization performance of a trained image recognition model.

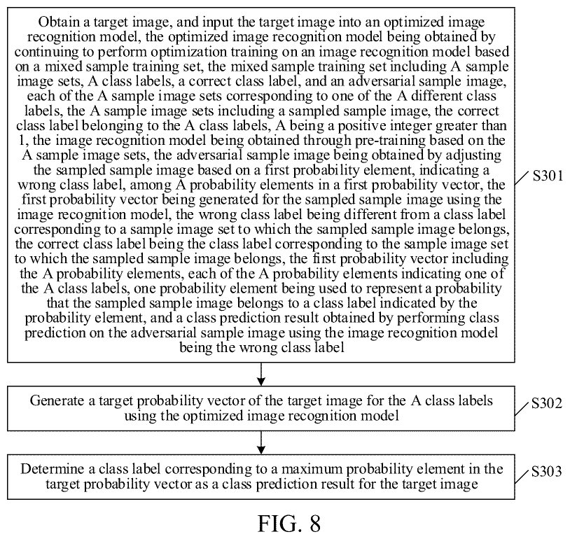

FIG. 8 is a schematic flowchart of a data processing method according to some embodiments. The method may be performed by a service server (for example, the service server 100 shown in FIG. 1), may be performed by a terminal device (for example, the terminal device 200a shown in FIG. 1), or may be performed interactively by a service server and a terminal device. For ease of understanding, an example in which the method is performed by the service server is used for description. As shown in FIG. 8, the method may include at least the following operations.

Operation S301: Obtain a target image, and input the target image into an optimized image recognition model, the optimized image recognition model being obtained by continuing to perform optimization training on an image recognition model based on a mixed sample training set, the mixed sample training set including A sample image sets, A class labels, a correct class label, and an adversarial sample image, each of the A sample image sets corresponding to one of the A different class labels, the A sample image sets including a sampled sample image, the correct class label belonging to the A class labels, A being a positive integer greater than 1, the image recognition model being obtained through pre-training based on the A sample image sets, the adversarial sample image being obtained by adjusting the sampled sample image based on a first probability element, indicating a wrong class label, among A probability elements in a first probability vector, the first probability vector being generated for the sampled sample image using the image recognition model, the wrong class label being different from a class label corresponding to a sample image set to which the sampled sample image belongs, the correct class label being the class label corresponding to the sample image set to which the sampled sample image belongs, the first probability vector including the A probability elements, each of the A probability elements indicating one of the A class labels, one probability element being used to represent a probability that the sampled sample image belongs to a class label indicated by the probability element, and a class prediction result obtained by performing class prediction on the adversarial sample image using the image recognition model being the wrong class label.

Operation S302: Generate a target probability vector of the target image for the A class labels using the optimized image recognition model.

Operation S303: Determine a class label corresponding to a maximum probability element in the target probability vector as a class prediction result for the target image.

In some embodiments, the image recognition model may be used to recognize a real object, for example, a real human. In this case, the image recognition model may be referred to as a real object detection model. In a current intelligent object recognition payment service, more and more real object detection technologies are applied to products, providing a powerful guarantee for safety in payment. However, in an actual application scenario of real object detection, there are a wide variety of attacks brought by criminals, with novel attack forms that are difficult to guard against. For example, in a paper attack, among numerous types of materials, there is always one type that the model has not been trained on. Therefore, it can bypass the real object detection model and implement an attack. This problem also exists in high-precision three-dimensional attacks. Once a new material appears, the real object detection model may not be able to defend. The root cause is that training data fails to cover the entire class space. Therefore, some embodiments provide a brand-new real object detection technology based on adversarial data enhancement with a boundary constraint. A particular adversarial sample image is designed to enhance real object training data, to improve the whole real object detection performance. For a specific generation process of the adversarial sample image, refer to the foregoing descriptions in the embodiments respectively corresponding to FIG. 3 and FIG. 7.

Based on the foregoing, some embodiments provide a method for generating an adversarial sample image. According to the method, the adversarial sample image misrecognized by the image recognition model may be generated. The adversarial sample image can improve sample diversity of a training set for optimization training of the image recognition model. The training set with diversified samples can improve accuracy of optimization training of the image recognition model, thereby improving class label recognition accuracy and recognition generalization performance of a trained image recognition model.

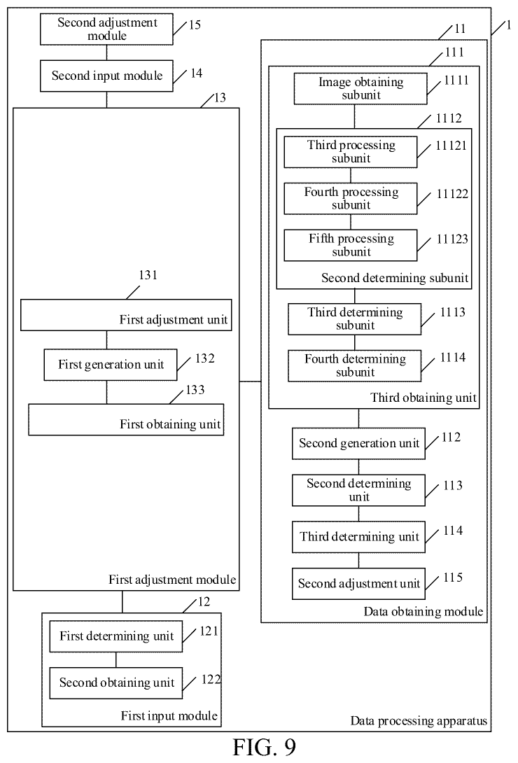

FIG. 9 is a schematic diagram 1 of a structure of a data processing apparatus according to some embodiments. The data processing apparatus 1 may be configured to perform corresponding operations in the method provided in some embodiments. As shown in FIG. 9, the image data processing apparatus 1 may include a data obtaining module 11, a first input module 12, and a first adjustment module 13.

The data obtaining module 11 is configured to obtain A sample image sets and an image recognition model, A being a positive integer greater than 1, each of the A sample image sets corresponding to one of A different class labels, the image recognition model being obtained through pre-training based on the A sample image sets, and the A class labels including a wrong class label.

The first input module 12 is configured to obtain a sampled sample image from the A sample image sets, and input the sampled sample image and the wrong class label into the image recognition model, to generate a first probability vector of the sampled sample image for the A class labels, the wrong class label being different from a class label corresponding to a sample image set to which the sampled sample image belongs, the first probability vector including A probability elements, each of the A probability elements indicating one of the A class labels, and one probability element being used to represent a probability that the sampled sample image belongs to a class label indicated by the probability element.

The first adjustment module 13 is configured to obtain, from the A probability elements in the first probability vector, a first probability element indicating the wrong class label, and adjust the sampled sample image based on the first probability element, to obtain an adversarial sample image corresponding to the sampled sample image, a class prediction result obtained by performing class prediction on the adversarial sample image using the image recognition model being the wrong class label.

For specific implementations of functions of the data obtaining module 11, the first input module 12, and the first adjustment module 13, refer to the descriptions of operation S101 to operation S103 in the embodiment corresponding to FIG. 3. Details are not described herein again.

The first adjustment module 13 may be configured to generate a negative probability element corresponding to the first probability element, perform summation processing on the negative probability element and a maximum probability element in the first probability vector, to obtain a label loss value of the sampled sample image for the wrong class label, and adjust the sampled sample image based on the label loss value, to obtain the adversarial sample image corresponding to the sampled sample image.

When configured to adjust the sampled sample image based on the label loss value, to obtain the adversarial sample image corresponding to the sampled sample image, the first adjustment module 13 is configured to generate an initial gradient value for the sampled sample image based on the label loss value, obtain a numerical sign of the initial gradient value, generate, based on the numerical sign, a signed unit value corresponding to the initial gradient value, perform product processing on an initial learning rate and the signed unit value to obtain a first to-be-clipped value, perform clipping processing on the first to-be-clipped value using a first clipping interval generated based on an attack intensity, to obtain a gradient value for adjusting the sampled sample image, perform difference calculation processing on the sampled sample image and the gradient value to obtain a second to-be-clipped value, and perform clipping processing on the second to-be-clipped value using a second clipping interval generated based on a pixel level, to obtain the adversarial sample image corresponding to the sampled sample image.

The first adjustment module 13 may include a first adjustment unit 131, a first generation unit 132, and a first obtaining unit 133.

The first adjustment unit 131 is configured to adjust the sampled sample image based on the first probability element, to obtain an initial adversarial sample image corresponding to the sampled sample image.

The first generation unit 132 is configured to input the wrong class label and the initial adversarial sample image into the image recognition model, and generate a second probability vector of the initial adversarial sample image for the A class labels using the image recognition model.

The first obtaining unit 133 is configured to obtain a second probability element for the wrong class label from A probability elements included in the second probability vector.

The first adjustment unit 131 is further configured to continue to adjust the initial adversarial sample image based on the second probability element if the second probability element does not satisfy a boundary constraint or the class prediction result obtained by performing class prediction on the adversarial sample image is not the wrong class label.

The first obtaining unit 133 is further configured to determine, if the second probability element satisfies a boundary constraint or the class prediction result obtained by performing class prediction on the adversarial sample image is the wrong class label, the initial adversarial sample image as the adversarial sample image corresponding to the sampled sample image, the second probability element being a maximum value among the A probability elements included in the second probability vector in a case that the class prediction result is the wrong class label.

For specific implementations of functions of the first adjustment unit 131, the first generation unit 132, and the first obtaining unit 133, refer to the descriptions of operation S103 in the embodiment corresponding to FIG. 3. Details are not described herein again.

The first obtaining unit 133 is further configured to compare the second probability element with a probability constraint value, the probability constraint value being a reciprocal of A.

The first obtaining unit 133 is further configured to determine, if the second probability element is less than the probability constraint value, that the second probability element does not satisfy the boundary constraint.

The first obtaining unit 133 is further configured to determine, if the second probability element is greater than or equal to the probability constraint value, that the second probability element satisfies the boundary constraint.

The data processing apparatus 1 may further include a second input module 14 and a second adjustment module 15.

The second input module 14 is configured to input the A sample image sets, the A class labels, a correct class label, and the adversarial sample image into the image recognition model, the correct class label being the class label corresponding to the sample image set to which the sampled sample image belongs.

The second input module 14 is further configured to generate, using the image recognition model, first predicted classes respectively corresponding to the A sample image sets and a second predicted class corresponding to the adversarial sample image.

The second adjustment module 15 is configured to generate a first loss value based on the first predicted classes and the A class labels, generate a second loss value based on the second predicted class and the correct class label, and adjust a parameter in the image recognition model based on the first loss value and the second loss value, to obtain an optimized image recognition model, a class prediction result obtained by performing class prediction on the adversarial sample image using the optimized image recognition model being the correct class label.

For specific implementations of functions of the second input module 14 and the second adjustment module 15, refer to the descriptions of operation S204 to operation S206 in the embodiment corresponding to FIG. 7. Details are not described herein again.

The first input module 12 may include a first determining unit 121 and a second obtaining unit 122.

The A sample image sets include the sample image set Cb, b being a positive integer, and b being less than or equal to A.

The first determining unit 121 is configured to determine a sampling ratio, and perform sampling processing on a sample image in the sample image set Cb based on the sampling ratio, to obtain the sampled sample image.

The second obtaining unit 122 is configured to obtain, from the A class labels, a class label different from a class label for the sample image set Cb, and determine the obtained class label as the wrong class label.

For specific implementations of functions of the first determining unit 121 and the second obtaining unit 122, refer to the descriptions of operation S102 in the embodiment corresponding to FIG. 3. Details are not described herein again.

The data obtaining module 11 may include a third obtaining unit 111, a second generation unit 112, a second determining unit 113, a third determining unit 114, and a second adjustment unit 115.

The third obtaining unit 111 is configured to obtain the A sample image sets, and separately input the A class labels and the A sample image sets into an initial image recognition model.

The second generation unit 112 is configured to generate, using the initial image recognition model, predicted initial classes respectively corresponding to the A sample image sets.

The second determining unit 113 is configured to determine, based on the predicted initial classes and the A class labels, class loss values respectively corresponding to the A sample image sets.

The third determining unit 114 is configured to determine, based on the class loss values respectively corresponding to the A sample image sets, a total loss value corresponding to the initial image recognition model.

The second adjustment unit 115 is configured to adjust a parameter in the initial image recognition model based on the total loss value, to obtain the image recognition model, a class prediction result obtained by performing class prediction on the sample image set Cb using the image recognition model being the class label for the sample image set Cb, the A sample image sets including the sample image set Cb, b being a positive integer, and b being less than or equal to A.

For specific implementations of functions of the third obtaining unit 111, the second generation unit 112, the second determining unit 113, the third determining unit 114, and the second adjustment unit 115, refer to the descriptions of operation S101 in the embodiment corresponding to FIG. 3. Details are not described herein again.

The third obtaining unit 111 may include an image obtaining subunit 1111, a second determining subunit 1112, a third determining subunit 1113, and a fourth determining subunit 1114.

The image obtaining subunit 1111 is configured to obtain A original image sets, and input all the A original image sets into an object detection model, the A original image sets corresponding to different class information, the A original image sets including an original image set D_{b}, the original image set D_{b} including an original image E_{f}, f being a positive integer, and f being less than or equal to a total quantity of original images in the original image set D_{b}.

The second determining subunit 1112 is configured to determine regional coordinates of a key region in the original image E_{f} using the object detection model, and generate, based on the regional coordinates, a to-be-labeled sample image corresponding to the original image E_{f}.

The third determining subunit 1113 is configured to determine a to-be-labeled sample image corresponding to each original image in the original image set D_{b} as a to-be-labeled sample image set.

The fourth determining subunit 1114 is configured to generate a class label H_{b} based on class information corresponding to the original image set D_{b}, and determine a to-be-labeled sample image set labeled with the class label H_{b} as the sample image set C_{b}.

For specific implementations of functions of the image obtaining subunit 1111, the second determining subunit 1112, the third determining subunit 1113, and the fourth determining subunit 1114, refer to the descriptions of operation S201 in the embodiment corresponding to FIG. 7. Details are not described herein again.

The second determining subunit 1112 may include a third processing subunit 11121, a fourth processing subunit 11122, and a fifth processing subunit 11123.

The third processing subunit 11121 is configured to generate, based on the regional coordinates, an initial detection box including the key region, and perform expansion processing on the initial detection box to obtain a detection box including a target object, the key region belonging to the target object.

The fourth processing subunit 11122 is configured to obtain, from the detection box, a to-be-scaled image including the target object, obtain a first image size, and perform scaling processing on the to-be-scaled image based on the first image size, to obtain a to-be-cropped image.

The fifth processing subunit 11123 is configured to obtain a second image size, and perform cropping processing on the to-be-cropped image based on the second image size, to obtain the to-be-labeled sample image corresponding to the original image Ef, the second image size being smaller than the first image size.

For specific implementations of functions of the third processing subunit 11121, the fourth processing subunit 11122, and the fifth processing subunit 11123, refer to the descriptions of operation S201 in the embodiment corresponding to FIG. 7. Details are not described herein again.

Based on the foregoing, some embodiments provide a method for generating an adversarial sample image. According to the method, the adversarial sample image misrecognized by the image recognition model may be generated. The adversarial sample image can improve sample diversity of a training set for optimization training of the image recognition model. The training set with diversified samples can improve accuracy of optimization training of the image recognition model, thereby improving class label recognition accuracy and recognition generalization performance of a trained image recognition model. In addition, since the second probability element for the wrong class label that is predicted by the image recognition model for the adversarial sample image satisfies the boundary constraint, the classification interface of the image recognition model obtained through optimization training is more gentile, further ensuring model accuracy.

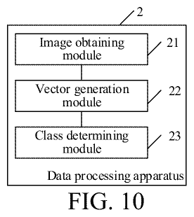

FIG. 10 is a schematic diagram of a structure of a data processing apparatus according to some embodiments. The data processing apparatus 2 may be configured to perform corresponding operations in the method provided in some embodiments. As shown in FIG. 10, the image data processing apparatus 2 may include an image obtaining module 21, a vector generation module 22, and a class determining module 23.

The image obtaining module 21 is configured to obtain a target image, and input the target image into an optimized image recognition model, the optimized image recognition model being obtained by continuing to perform optimization training on an image recognition model based on a mixed sample training set, the mixed sample training set including A sample image sets, A class labels, a correct class label, and an adversarial sample image, each of the A sample image sets corresponding to one of the A different class labels, the A sample image sets including a sampled sample image, the correct class label belonging to the A class labels, A being a positive integer greater than 1, the image recognition model being obtained through pre-training based on the A sample image sets, the adversarial sample image being obtained by adjusting the sampled sample image based on a first probability element, indicating a wrong class label, among A probability elements in a first probability vector, the first probability vector being generated for the sampled sample image using the image recognition model, the wrong class label being different from a class label corresponding to a sample image set to which the sampled sample image belongs, the correct class label being the class label corresponding to the sample image set to which the sampled sample image belongs, the first probability vector including the A probability elements, each of the A probability elements indicating one of the A class labels, one probability element being used to represent a probability that the sampled sample image belongs to a class label indicated by the probability element, and a class prediction result obtained by performing class prediction on the adversarial sample image using the image recognition model being the wrong class label.

The vector generation module 22 is configured to generate a target probability vector of the target image for the A class labels using the optimized image recognition model.

The class determining module 23 is configured to determine a class label corresponding to a maximum probability element in the target probability vector as a class prediction result for the target image.

For specific implementations of functions of the image obtaining module 21, the vector generation module 22, and the class determining module 23, refer to the descriptions of operation S301 to operation S303 in the embodiment corresponding to FIG. 8. Details are not described herein again.

According to some embodiments, each module in the apparatus may exist respectively or be combined into one or more units. Certain (or some) unit in the units may be further split into multiple smaller function subunits, thereby implementing the same operations without affecting the technical effects of some embodiments. The modules are divided based on logical functions. In actual applications, a function of one module may be realized by multiple units, or functions of multiple modules may be realized by one unit. In some embodiments, the apparatus may further include other units. In actual applications, these functions may also be realized cooperatively by the other units, and may be realized cooperatively by multiple units.

A person skilled in the art would understand that these “modules” and “units” could be implemented by hardware logic, a processor or processors executing computer software code, or a combination of both. The “modules” and “units” may also be implemented in software stored in a memory of a computer or a non-transitory computer-readable medium, where the instructions of each module and unit are executable by a processor to thereby cause the processor to perform the respective operations of the corresponding module and unit.

Based on the foregoing, some embodiments describe a method for generating an adversarial sample image. According to the method, the adversarial sample image misrecognized by the image recognition model may be generated. The adversarial sample image can improve sample diversity of a training set for optimization training of the image recognition model. The training set with diversified samples can improve accuracy of optimization training of the image recognition model, thereby improving class label recognition accuracy and recognition generalization performance of a trained image recognition model.

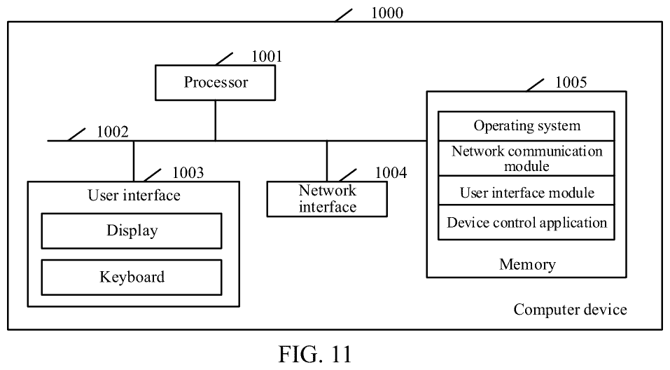

FIG. 11 is a schematic diagram of a structure of a computer device according to some embodiments. As shown in FIG. 11, the computer device 1000 may include at least one processor 1001, for example, a central processing unit (CPU), at least one network interface 1004, a user interface 1003, a memory 1005, and at least one communication bus 1002. The communication bus 1002 is configured to implement connection and communication between these components. In some embodiments, the user interface 1003 may include a display and a keyboard. In some embodiments, the network interface 1004 may include a standard wired interface and a standard wireless interface (for example, a wireless fidelity (Wi-Fi) interface). The memory 1005 may be a high-speed random access memory (RAM), or may be a non-volatile memory, for example, at least one magnetic disk memory. In some embodiments, the memory 1005 may be at least one storage apparatus that is located far away from the foregoing processor 1001. As shown in FIG. 11, the memory 1005 used as a computer storage medium may include an operating system, a network communication module, a user interface module, and a device control application.

In the computer device 1000 shown in FIG. 11, the network interface 1004 may provide a network communication function. The user interface 1003 is mainly configured to provide an input interface for a user. The processor 1001 may be configured to invoke the device control application stored in the memory 1005 to implement: obtaining A sample image sets and an image recognition model, A being a positive integer greater than 1, each of the A sample image sets corresponding to one of A different class labels, the image recognition model being obtained through pre-training based on the A sample image sets, and the A class labels including a wrong class label; obtaining a sampled sample image from the A sample image sets, and inputting the sampled sample image and the wrong class label into the image recognition model, to generate a first probability vector of the sampled sample image for the A class labels, the wrong class label being different from a class label corresponding to a sample image set to which the sampled sample image belongs, the first probability vector including A probability elements, each of the A probability elements indicating one of the A class labels, and one probability element being used to represent a probability that the sampled sample image belongs to a class label indicated by the probability element; and obtaining, from the A probability elements in the first probability vector, a first probability element indicating the wrong class label, and adjusting the sampled sample image based on the first probability element, to obtain an adversarial sample image corresponding to the sampled sample image, a class prediction result obtained by performing class prediction on the adversarial sample image using the image recognition model being the wrong class label.

In some embodiments, the processor 1001 may be configured to invoke the device control application stored in the memory 1005 to implement: obtaining a target image, and inputting the target image into an optimized image recognition model, the optimized image recognition model being obtained by continuing to perform optimization training on an image recognition model based on a mixed sample training set, the mixed sample training set including A sample image sets, A class labels, a correct class label, and an adversarial sample image, each of the A sample image sets corresponding to one of the A different class labels, the A sample image sets including a sampled sample image, the correct class label belonging to the A class labels, A being a positive integer greater than 1, the image recognition model being obtained through pre-training based on the A sample image sets, the adversarial sample image being obtained by adjusting the sampled sample image based on a first probability element, indicating a wrong class label, among A probability elements in a first probability vector, the first probability vector being generated for the sampled sample image using the image recognition model, the wrong class label being different from a class label corresponding to a sample image set to which the sampled sample image belongs, the correct class label being the class label corresponding to the sample image set to which the sampled sample image belongs, the first probability vector including the A probability elements, each of the A probability elements indicating one of the A class labels, one probability element being used to represent a probability that the sampled sample image belongs to a class label indicated by the probability element, and a class prediction result obtained by performing class prediction on the adversarial sample image using the image recognition model being the wrong class label; generating a target probability vector of the target image for the A class labels using the optimized image recognition model; and determining a class label corresponding to a maximum probability element in the target probability vector as a class prediction result for the target image.

The computer device 1000 according to some embodiments can implement the descriptions of the data processing method or apparatus in the foregoing embodiments. Details are not described herein again. In addition, the descriptions of beneficial effects of the same method are not described herein again.

Some embodiments further provide a non-transitory computer-readable storage medium, having a computer program stored therein. When the computer program is executed by a processor, the descriptions of the data processing method or apparatus in the foregoing embodiments are implemented. Details are not described herein again. In addition, the descriptions of beneficial effects of the same method are not described herein again.

The computer-readable storage medium may be an internal storage unit of the data processing apparatus or the computer device provided in any one of the foregoing embodiments, for example, a hard disk or an internal memory of the computer device. The computer-readable storage medium may be an external storage device of the computer device, for example, a plug-in hard disk, a smart media card (SMC), a secure digital (SD) card, or a flash card on the computer device. Further, the computer-readable storage medium may include both an internal storage unit and an external storage device of the computer device. The computer-readable storage medium is configured to store the computer program and another program and data that are required by the computer device. The computer-readable storage medium may further be configured to temporarily store data that has been output or is to be output.

Some embodiments further provide a computer program product, including a computer program. The computer program is stored in a computer-readable storage medium. A processor of a computer device reads the computer program from the computer-readable storage medium. The processor executes the computer program, to cause the computer device to implement the descriptions of the data processing method or apparatus in the foregoing embodiments. Details are not described herein again. In addition, the descriptions of beneficial effects of the same method are not described herein again.

The terms “first”, “second”, and the like are used to distinguish between different objects rather than describe a specific sequence. In addition, the term “include” and any variant thereof are intended to cover a non-exclusive inclusion. For example, a process, method, apparatus, product, or device that includes a series of operations or units is not limited to the listed operations or modules; and instead, in some embodiments, further includes an operation or module that is not listed, or in some embodiments, further includes another operation or unit that is intrinsic to the process, method, apparatus, product, or device.

A person of ordinary skill in the art may be aware that, in combination with the examples described in the embodiments disclosed herein, units and algorithm operations may be implemented by electronic hardware, computer software, or a combination thereof. To clearly describe the interchangeability between the hardware and the software, the foregoing has generally described compositions and operations of each example according to functions. Whether the functions are executed in a mode of hardware or software depends on particular applications and design constraint conditions of the technical solutions. A person skilled in the art may use different methods to implement the described functions for each particular application, but it shall not be considered that the implementation goes beyond the scope of this application.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data processing method, performed by a computer device, comprising:
obtaining N sample image sets and an image recognition model, N being a positive integer greater than 1, each of the N sample image sets corresponding to one of N different class labels, the image recognition model being obtained through pre-training based on the N sample image sets, and the N class labels comprising a wrong class label;
obtaining a sampled sample image from the N sample image sets, and inputting the sampled sample image and the wrong class label into the image recognition model, to generate a first probability vector of the sampled sample image for the N class labels, the wrong class label being different from a class label corresponding to a sample image set to which the sampled sample image belongs, the first probability vector comprising N probability elements, each of the N probability elements indicating one of the N class labels, and one probability element being used to represent a probability that the sampled sample image belongs to a class label indicated by the probability element; and
obtaining, from the N probability elements in the first probability vector, a first probability element indicating the wrong class label, and adjusting the sampled sample image based on the first probability element, to obtain an adversarial sample image corresponding to the sampled sample image, a class prediction result obtained by performing class prediction on the adversarial sample image using the image recognition model being the wrong class label.

2. The data processing method according to claim 1, wherein the adjusting the sampled sample image based on the first probability element comprises:
generating a negative probability element corresponding to the first probability element, and performing summation processing on the negative probability element and a maximum probability element in the first probability vector to obtain a label loss value of the sampled sample image for the wrong class label; and
adjusting the sampled sample image based on the label loss value to obtain the adversarial sample image corresponding to the sampled sample image.

3. The data processing method according to claim 2, wherein the adjusting the sampled sample image based on the label loss value comprises:
generating an initial gradient value for the sampled sample image based on the label loss value, obtaining a numerical sign of the initial gradient value, and generating, based on the numerical sign, a signed unit value corresponding to the initial gradient value;
performing product processing on an initial learning rate and the signed unit value to obtain a first to-be-clipped value, and performing clipping processing on the first to-be-clipped value using a first clipping interval generated based on an attack intensity to obtain a gradient value for adjusting the sampled sample image; and
performing difference calculation processing on the sampled sample image and the gradient value to obtain a second to-be-clipped value, and performing clipping processing on the second to-be-clipped value using a second clipping interval generated based on a pixel level to obtain the adversarial sample image corresponding to the sampled sample image.

4. The data processing method according to claim 1, wherein the adjusting the sampled sample image based on the first probability element comprises:
adjusting the sampled sample image based on the first probability element to obtain an initial adversarial sample image corresponding to the sampled sample image;
inputting the wrong class label and the initial adversarial sample image into the image recognition model, and generating a second probability vector of the initial adversarial sample image for the N class labels using the image recognition model;
obtaining a second probability element for the wrong class label from N probability elements comprised in the second probability vector; and
continuing to adjust the initial adversarial sample image based on the second probability element if the second probability element does not satisfy a boundary constraint or the class prediction result obtained by performing class prediction on the adversarial sample image is not the wrong class label; or
determining, if the second probability element satisfies a boundary constraint or the class prediction result obtained by performing class prediction on the adversarial sample image is the wrong class label, the initial adversarial sample image as the adversarial sample image corresponding to the sampled sample image, the second probability element being a maximum value among the N probability elements comprised in the second probability vector in a case that the class prediction result is the wrong class label.

5. The data processing method according to claim 1, further comprising:
comparing the second probability element with a probability constraint value, the probability constraint value being a reciprocal of N; and
determining, if the second probability element is less than the probability constraint value, that the second probability element does not satisfy the boundary constraint; or
determining, if the second probability element is greater than or equal to the probability constraint value, that the second probability element satisfies the boundary constraint.

6. The data processing method according to claim 1, further comprising:
inputting the N sample image sets, the N class labels, a correct class label, and the adversarial sample image into the image recognition model, the correct class label being the class label corresponding to the sample image set to which the sampled sample image belongs;
generating, using the image recognition model, first predicted classes respectively corresponding to the N sample image sets and a second predicted class corresponding to the adversarial sample image; and
generating a first loss value based on the first predicted classes and the N class labels, generating a second loss value based on the second predicted class and the correct class label, and adjusting a parameter in the image recognition model based on the first loss value and the second loss value, to obtain an optimized image recognition model, a class prediction result obtained by performing class prediction on the adversarial sample image using the optimized image recognition model being the correct class label.

7. The data processing method according to claim 1, wherein the N sample image sets comprise a sample image set; and the obtaining a sampled sample image from the N sample image sets comprises:
determining a sampling ratio, and performing sampling processing on a sample image in the sample image set based on the sampling ratio to obtain the sampled sample image; and
obtaining, from the N class labels, a class label different from a class label for the sample image set, and determining the obtained class label as the wrong class label.

8. The data processing method according to claim 1, wherein the obtaining N sample image sets and an image recognition model comprises:
obtaining the N sample image sets, and separately inputting the N class labels and the N sample image sets into an initial image recognition model;
generating, using the initial image recognition model, predicted initial classes respectively corresponding to the N sample image sets;
determining, based on the predicted initial classes and the N class labels, class loss values respectively corresponding to the N sample image sets;
determining, based on the class loss values respectively corresponding to the N sample image sets, a total loss value corresponding to the initial image recognition model; and
adjusting a parameter in the initial image recognition model based on the total loss value, to obtain the image recognition model, a class prediction result obtained by performing class prediction on the sample image set using the image recognition model being the class label for the sample image set, the N sample image sets comprising a sample image set.

9. The data processing method according to claim 8, wherein the obtaining N sample image sets comprises:
obtaining N original image sets, and inputting all the N original image sets into an object detection model, each of the N original image sets corresponding to one of N different pieces of class information, the N original image sets comprising an original image set, the original image set comprising an original image;
determining regional coordinates of a key region in the original image using the object detection model, and generating, based on the regional coordinates, a to-be-labeled sample image corresponding to the original image;
determining the to-be-labeled sample image corresponding to each original image in the original image set as a to-be-labeled sample image set; and
generating a class label based on class information corresponding to the original image set, and determining a to-be-labeled sample image set labeled with the class label as the sample image set.

10. The data processing method according to claim 9, wherein the generating, based on the regional coordinates, a to-be-labeled sample image corresponding to the original image comprises:
generating, based on the regional coordinates, an initial detection box comprising the key region, and performing expansion processing on the initial detection box to obtain a detection box comprising a target object, the key region belonging to the target object;
obtaining, from the detection box, a to-be-scaled image comprising the target object, obtaining a first image size, and performing scaling processing on the to-be-scaled image based on the first image size, to obtain a to-be-cropped image; and
obtaining a second image size, and performing cropping processing on the to-be-cropped image based on the second image size, to obtain the to-be-labeled sample image corresponding to the original image, the second image size being smaller than the first image size.

11. A data processing apparatus, comprising:
at least one memory configured to store program code; and
at least one processor configured to read the program code and operate as instructed by the program code, the program code comprising:
data obtaining code configured to cause at least one of the at least one processor to obtain N sample image sets and an image recognition model, N being a positive integer greater than 1, each of the N sample image sets corresponding to one of N different class labels, the image recognition model being obtained through pre-training based on the N sample image sets, and the N class labels comprising a wrong class label;
first input code configured to cause at least one of the at least one processor to obtain a sampled sample image from the N sample image sets, and input the sampled sample image and the wrong class label into the image recognition model, to generate a first probability vector of the sampled sample image for the N class labels, the wrong class label being different from a class label corresponding to a sample image set to which the sampled sample image belongs, the first probability vector comprising A probability elements, each of the N probability elements indicating one of the N class labels, and one probability element being used to represent a probability that the sampled sample image belongs to a class label indicated by the probability element; and
first adjustment code configured to cause at least one of the at least one processor to obtain, from the N probability elements in the first probability vector, a first probability element indicating the wrong class label, and adjust the sampled sample image based on the first probability element, to obtain an adversarial sample image corresponding to the sampled sample image, a class prediction result obtained by performing class prediction on the adversarial sample image using the image recognition model being the wrong class label.

12. The data processing apparatus according to claim 11, wherein the first adjustment code is further configured to cause at least one of the at least one processor to:
generate a negative probability element corresponding to the first probability element, and perform summation processing on the negative probability element and a maximum probability element in the first probability vector to obtain a label loss value of the sampled sample image for the wrong class label; and
adjust the sampled sample image based on the label loss value to obtain the adversarial sample image corresponding to the sampled sample image.

13. The data processing apparatus according to claim 12, wherein the first adjustment code is further configured to cause at least one of the at least one processor to:
generate an initial gradient value for the sampled sample image based on the label loss value, obtain a numerical sign of the initial gradient value, and generate, based on the numerical sign, a signed unit value corresponding to the initial gradient value;
perform product processing on an initial learning rate and the signed unit value to obtain a first to-be-clipped value, and perform clipping processing on the first to-be-clipped value using a first clipping interval generated based on an attack intensity to obtain a gradient value for adjusting the sampled sample image; and
perform difference calculation processing on the sampled sample image and the gradient value to obtain a second to-be-clipped value, and perform clipping processing on the second to-be-clipped value using a second clipping interval generated based on a pixel level to obtain the adversarial sample image corresponding to the sampled sample image.

14. The data processing apparatus according to claim 11, wherein the first adjustment code is further configured to cause at least one of the at least one processor to:
adjust the sampled sample image based on the first probability element to obtain an initial adversarial sample image corresponding to the sampled sample image;
input the wrong class label and the initial adversarial sample image into the image recognition model, and generate a second probability vector of the initial adversarial sample image for the N class labels using the image recognition model;
obtain a second probability element for the wrong class label from N probability elements comprised in the second probability vector; and
continue to adjust the initial adversarial sample image based on the second probability element if the second probability element does not satisfy a boundary constraint or the class prediction result obtained by performing class prediction on the adversarial sample image is not the wrong class label; or
determine, if the second probability element satisfies a boundary constraint or the class prediction result obtained by performing class prediction on the adversarial sample image is the wrong class label, the initial adversarial sample image as the adversarial sample image corresponding to the sampled sample image, the second probability element being a maximum value among the N probability elements comprised in the second probability vector in a case that the class prediction result is the wrong class label.

15. The data processing apparatus according to claim 11, wherein the first adjustment code is further configured to cause at least one of the at least one processor to:
compare the second probability element with a probability constraint value, the probability constraint value being a reciprocal of N; and
determine, if the second probability element is less than the probability constraint value, that the second probability element does not satisfy the boundary constraint; or
determine, if the second probability element is greater than or equal to the probability constraint value, that the second probability element satisfies the boundary constraint.

16. The data processing apparatus according to claim 11, wherein the program code further comprises:
second input code configured to cause at least one of the at least one processor to:
input the N sample image sets, the N class labels, a correct class label, and the adversarial sample image into the image recognition model, the correct class label being the class label corresponding to the sample image set to which the sampled sample image belongs;
generate, using the image recognition model, first predicted classes respectively corresponding to the N sample image sets and a second predicted class corresponding to the adversarial sample image; and
second adjustment code configured to cause at least one of the at least one processor to generate a first loss value based on the first predicted classes and the N class labels, generate a second loss value based on the second predicted class and the correct class label, and adjust a parameter in the image recognition model based on the first loss value and the second loss value, to obtain an optimized image recognition model, a class prediction result obtained by performing class prediction on the adversarial sample image using the optimized image recognition model being the correct class label.

17. The data processing apparatus according to claim 11, wherein the N sample image sets comprise a sample image set; and
wherein the first input code is further configured to cause at least one of the at least one processor to:
determine a sampling ratio, and performing sampling processing on a sample image in the sample image set based on the sampling ratio to obtain the sampled sample image; and
obtain, from the N class labels, a class label different from a class label for the sample image set, and determining the obtained class label as the wrong class label.

18. The data processing apparatus according to claim 11, wherein the data obtaining code is further configured to cause at least one of the at least one processor to:
obtain the N sample image sets, and separately input the N class labels and the N sample image sets into an initial image recognition model;
generate, using the initial image recognition model, predicted initial classes respectively corresponding to the N sample image sets;
determine, based on the predicted initial classes and the N class labels, class loss values respectively corresponding to the N sample image sets;
determine, based on the class loss values respectively corresponding to the N sample image sets, a total loss value corresponding to the initial image recognition model; and
adjust a parameter in the initial image recognition model based on the total loss value, to obtain the image recognition model, a class prediction result obtained by performing class prediction on the sample image set using the image recognition model being the class label for the sample image set, the N sample image sets comprising a sample image set.

19. The data processing apparatus according to claim 18, wherein the data obtaining code is further configured to cause at least one of the at least one processor to:
obtain N original image sets, and input all the N original image sets into an object detection model, each of the N original image sets corresponding to one of N different pieces of class information, the N original image sets comprising an original image set, the original image set comprising an original image;
determine regional coordinates of a key region in the original image using the object detection model, and generate, based on the regional coordinates, a to-be-labeled sample image corresponding to the original image;
determine the to-be-labeled sample image corresponding to each original image in the original image set as a to-be-labeled sample image set; and
generate a class label based on class information corresponding to the original image set, and determine a to-be-labeled sample image set labeled with the class label as the sample image set.

20. A non-transitory computer-readable storage medium, storing computer code which, when executed by at least one processor, causes the at least one processor to at least:
obtain N sample image sets and an image recognition model, N being a positive integer greater than 1, each of the N sample image sets corresponding to one of N different class labels, the image recognition model being obtained through pre-training based on the N sample image sets, and the N class labels comprising a wrong class label;
obtain a sampled sample image from the N sample image sets, and input the sampled sample image and the wrong class label into the image recognition model, to generate a first probability vector of the sampled sample image for the N class labels, the wrong class label being different from a class label corresponding to a sample image set to which the sampled sample image belongs, the first probability vector comprising N probability elements, each of the N probability elements indicating one of the N class labels, and one probability element being used to represent a probability that the sampled sample image belongs to a class label indicated by the probability element; and
obtain, from the N probability elements in the first probability vector, a first probability element indicating the wrong class label, and adjust the sampled sample image based on the first probability element, to obtain an adversarial sample image corresponding to the sampled sample image, a class prediction result obtained by performing class prediction on the adversarial sample image using the image recognition model being the wrong class label.
